(19) United States
(12) Patent Application Publication
(10) Pub. No.: US 2008/0024683 A1
(43) Pub. Date: Jan. 31, 2008

(54) Overlapped multi-projector system with dithering

(76) Inventors: Niranjan Damera-Venkata, Fort Collins, CO (US); Nelson Liang An Chang, Fort Collins, CO (US); Simon Widdowson, Fort Collins, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/496,324

(22) Filed: Jul. 31, 2006

(51) Int. Cl. H04N 9/12; H04N 9/31

(52) U.S. Cl. 348/744; 348/383

(57) ABSTRACT

A method of displaying a high-resolution image with a multi-projector display system, including receiving a high-resolution image frame representative of a high-resolution image and generating a low-resolution sub-frame for each projector of a multi-projector display system based on the high-resolution image frame, each low-resolution sub-frame including a plurality of pixels with each pixel having an intensity level, wherein each projector projects a maximum number of unique intensity levels. The method further includes dithering the intensity levels of the pixels of each low-resolution sub-frame to one of the unique intensity levels of the associated projector differently for each projector to form a dithered low-resolution sub-frame such that the dithered low-resolution sub-frames, when simultaneously projected in an overlapping fashion, form a projected image representative of the high-resolution image and having a maximum number of unique projected intensity levels substantially equal to a sum of the maximum number of unique intensity levels of all the projectors.

### BACKGROUND

Two types of projection display systems are digital light processor (DLP) systems, and liquid crystal display (LCD) systems. It is desirable in some projection applications to provide a high lumen level output, but it is very costly to provide such output levels in existing DLP and LCD projection systems. Three choices exist for applications where high lumen levels are desired: (1) high-output projectors; (2) tiled, low-output projectors; and (3) superimposed, low-output projectors.

When information requirements are modest, a single high-output projector is typically employed. This approach dominates digital cinema today, and the images typically have a nice appearance. High-output projectors have the lowest lumen value (i.e., lumens per dollar). The lumen value of high output projectors is less than half of that found in low-end projectors. If the high output projector fails, the screen goes black. Also, parts and service are available for high output projectors only via a specialized niche market.

Tiled projection can deliver very high resolution, but it is difficult to hide the seams separating tiles, and output is often reduced to produce uniform tiles. Tiled projection can deliver the most pixels of information. For applications where large pixel counts are desired, such as command and control, tiled projection is a common choice. Registration, color, and brightness must be carefully controlled in tiled projection. Matching color and brightness is accomplished by attenuating output, which costs lumens. If a single projector fails in a tiled projection system, the composite image is ruined.

Superimposed projection provides excellent fault tolerance and full brightness utilization, but resolution is typically compromised. Algorithms that seek to enhance resolution by offsetting multiple projection elements have been previously proposed. These methods assume simple shift offsets between projectors, use frequency domain analyses, and rely on heuristic methods to compute component sub-frames. The proposed methods do not generate optimal sub-frames in real-time, do not take into account arbitrary relative geometric distortion and luminance (brightness) variations between the component projectors, and are generally limited to the bit-depth available from the individual component projectors.

### SUMMARY

One form of the present invention provides a method of displaying a high-resolution image. The method includes receiving a high-resolution image frame representative of a high-resolution image and generating a low-resolution sub-frame for each projector of a multi-projector display system based on the high-resolution image frame, each low-resolution sub-frame including a plurality of pixels with each pixel having an intensity level, wherein each projector projects a maximum number of unique intensity levels. The method further includes dithering the intensity levels of the pixels of each low-resolution sub-frame to one of the unique intensity levels of the associated projector differently for each projector to form a dithered low-resolution sub-frame such that the dithered low-resolution sub-frames, when simultaneously projected in an overlapping fashion, form a projected image representative of the high-resolution image and having a maximum number of unique projected intensity levels substantially equal to a sum of the maximum number of unique intensity levels of all the projectors.

### BRIEF DESCRIPTION OF THE DRAWINGS

FIG. 1 is a block diagram illustrating an image display system according to one embodiment of the present invention.

FIGS. 2A-2C are schematic diagrams illustrating the projection of two sub-frames according to one embodiment of the present invention.

FIG. 3 is a flow diagram illustrating one embodiment of a process for displaying a high-resolution image according to the present invention.

FIG. 4 is a diagram illustrating a model of an image formation process according to one embodiment of the present invention.

FIG. 5 is a diagram illustrating a process for formation of an initial sub-frame according to one embodiment of the present invention.

FIG. 6 is a flow diagram illustrating one embodiment of a process for determining a relative luminance matrix according to one embodiment of the present invention.

FIG. 7 is a diagram illustrating a model of an image formation process according to one embodiment of the present invention.

FIG. 8 is a diagram illustrating a process for formation of an initial sub-frame according to one embodiment of the present invention.

FIG. 9 is a diagram illustrating a process for determining a dither array according to one embodiment of the present invention.

FIG. 10 is a flow diagram illustrating a process for determining dither arrays according to one embodiment of the present invention.

FIG. 11 is a flow diagram illustrating a process for determining dither arrays according to one embodiment of the present invention.

FIG. 12 is a flow diagram illustrating a process for determining dither arrays according to one embodiment of the present invention.

### DETAILED DESCRIPTION

In the following Detailed Description, reference is made to the accompanying drawings, which form a part hereof, and in which is shown by way of illustration specific embodiments in which the invention may be practiced. In this regard, directional terminology, such as “top,” “bottom,” “front,” “back,” etc., may be used with reference to the orientation of the Figure(s) being described. Because components of embodiments of the present invention can be positioned in a number of different orientations, the directional terminology is used for purposes of illustration and is in no way limiting. It is to be understood that other embodiments may be utilized and structural or logical changes may be made without departing from the scope of the present invention. The following Detailed Description, therefore, is not to be taken in a limiting sense, and the scope of the present invention is defined by the appended claims.

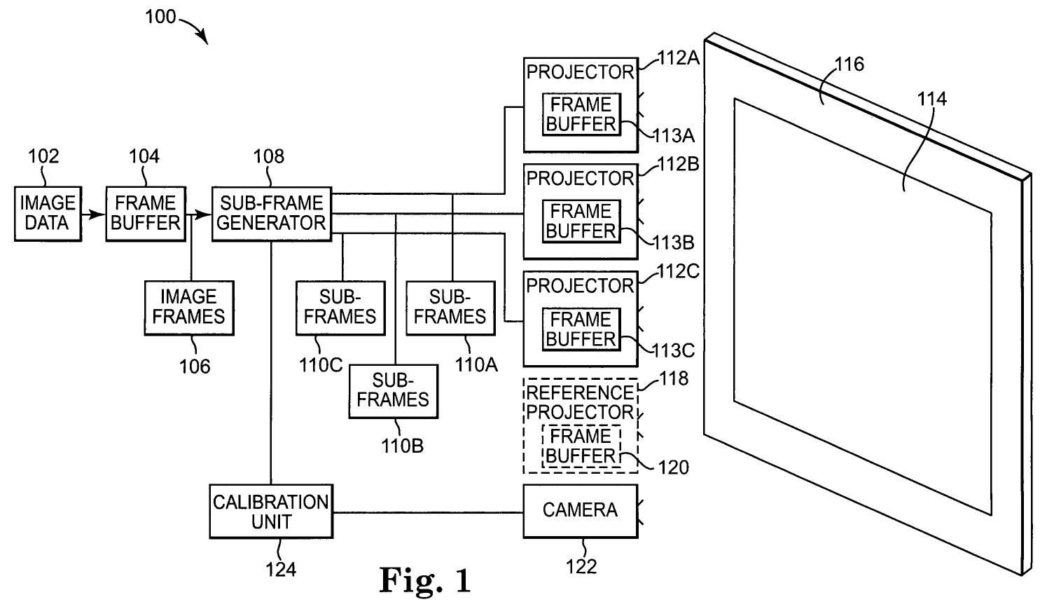

FIG. 1 is a block diagram illustrating an image display system 100 according to one embodiment of the present invention. Image display system 100 processes image data 102 and generates a corresponding displayed image 114. Displayed image 114 is defined to include any pictorial, graphical, or textural characters, symbols, illustrations, or other representations of information.

In one embodiment, image display system 100 includes image frame buffer 104, sub-frame generator 108, projectors 112A-112C (collectively referred to as projectors 112), camera 122, and calibration unit 124. Image frame buffer 104 receives and buffers image data 102 to create image frames 106. Sub-frame generator 108 processes image frames 106 to define corresponding image sub-frames 110A-110C (collectively referred to as sub-frames 110). In one embodiment, for each image frame 106, sub-frame generator 108 generates one sub-frame 110A for projector 112A, one sub-frame 110B for projector 112B, and one sub-frame 110C for projector 112C. The sub-frames 110A-110C are received by projectors 112A-112C, respectively, and stored in image frame buffers 113A-113C (collectively referred to as image frame buffers 113), respectively. Projectors 112A-112C project the sub-frames 110A-110C, respectively, onto target surface 116 to produce displayed image 114 for viewing by a user.

Image frame buffer 104 includes memory for storing image data 102 for one or more image frames 106. Thus, image frame buffer 104 constitutes a database of one or more image frames 106. Image frame buffers 113 also include memory for storing sub-frames 110. Examples of image frame buffers 104 and 113 include non-volatile memory (e.g., a hard disk drive or other persistent storage device) and may include volatile memory (e.g., random access memory (RAM)).

Sub-frame generator 108 receives and processes image frames 106 to define a plurality of image sub-frames 110. Sub-frame generator 108 generates sub-frames 110 based on image data in image frames 106. In one embodiment, sub-frame generator 108 generates image sub-frames 110 with a resolution that matches the resolution of projectors 112, which is less than the resolution of image frames 106 in one embodiment. Sub-frames 110 each include a plurality of columns and a plurality of rows of individual pixels representing a subset of an image frame 106.

Projectors 112 receive image sub-frames 110 from sub-frame generator 108 and, in one embodiment, simultaneously project the image sub-frames 110 onto target 116 at overlapping and spatially offset positions to produce displayed image 114. In one embodiment, display system 100 is configured to give the appearance to the human eye of high-resolution displayed images 114 by displaying overlapping and spatially shifted lower-resolution sub-frames 110 from multiple projectors 112. In one form of the invention, the projection of overlapping and spatially shifted sub-frames 110 gives the appearance of enhanced resolution (i.e., higher resolution than the sub-frames 110 themselves).

A problem of sub-frame generation, which is addressed by embodiments of the present invention, is to determine appropriate values for the sub-frames 110 so that the displayed image 114 produced by the projected sub-frames 110 is as close in appearance as possible as to how the high-resolution image frame (e.g., image frame 106) from which sub-frames 110 are derived would appear if displayed directly.

Projector tone curves generally vary from projector to projector. In conventional multi-projector tiled systems, the luminance (L) response of the individual projectors is generally adjusted so as to achieve an image that is seamless in appearance. To achieve this seamless appearance, the luminance responses of the projectors are generally downwardly adjusted to match the luminance response of the weakest projector(s). As such, the minimum luminance (L_{MIN}) provided by each of the projectors is adjusted to equal the L_{MIN} value of the projector having the highest L_{MIN} value, and the maximum luminance (L_{MAX}) provided by each of the projectors is adjusted to equal the L_{MAX} value of the projector having the lowest L_{MAX} value. In other words, with conventional multi-projector tiled systems, the luminance range provided by each of the projectors is adjusted so as to substantially equal the worst combination of the group of multiple projectors. As such, although conventional multi-projector tiled systems increase the resolution of a projected image by increasing the number of pixels employed to display the image, image brightness is sacrificed because the full brightness range of the projectors is not utilized.

In contrast, with a superimposed projector system according to one embodiment of the present invention, the brightness of the desired image ranges from a minimum luminance value (L_{MIN}), which is substantially equal to the sum of the minimum luminance values provided by each of the projects, to a maximum luminance value (L_{MAX}), which is substantially equal to the sum of the maximum luminance values provided by each of the projectors. As such, a superimposed projector system according to one embodiment of the present invention can render a desired image using substantially the full brightness range of the projectors.

In addition to varying between projectors, the luminance response of a single projector is typically non-linear in response to varying gray level inputs. Also, the luminance response of a given projector to a single gray level may vary spatially across the projected image. If these luminance variances are not accounted for, the superimposed multiple projector display system may not be able to utilize the full luminance range when projecting a desired image.

As such, in one embodiment, as will be described in greater detail below, the present invention provides a system and method that accounts for luminance variations between the multiple superimposed projectors when generating sub-frame values for each of the component projectors. By generating sub-frame values in this fashion, an image display system in accordance with one embodiment of the present invention, such as image display system 100, is able to utilize substantially the full combined brightness range of the multiple projectors when displaying a desired image. In one embodiment, the present invention provides algorithms to account for variations in the luminance of a projected image from multiple superimposed projectors.

Additionally, the bit-depth of images projected by conventional multi-projector tiled systems is generally limited to the bit depth of the individual component projectors. For example, a tiled system having two M-bit projectors is generally able to project 2^{M} unique levels. As such, two 8-bit projectors are able to project 256 unique levels.

As will be described in greater detail below, by dithering the sub-frames differently for each of the component projectors as described herein, such as by employing jointly designed dither arrays for each of the component projectors, an overlapping projection system in accordance with one embodiment of the present invention is able to project a maximum number of unique intensity levels which is substantially equal to a sum of the unique intensity levels capable of being projected by each of the component projectors. For example, an overlapping projection system in accordance with one embodiment of the present invention employing two M-bit projectors is able to project up to 2(2^{M})−1 bits (e.g. two superimposed 8-bit projectors are able to project up to 511 unique levels). Additionally, as mentioned above and described in greater detail below, an overlapping projection system in accordance with one embodiment of the present invention accounts for luminance variations between component projectors and individual spatial luminance variations of each component projector.

It will be understood by a person of ordinary skill in the art that functions performed by sub-frame generator 108 may be implemented in hardware, software, firmware, or any combination thereof. The implementation may be via a microprocessor, programmable logic device, or state machine. Components of the present invention may reside in software on one or more computer-readable mediums. The term computer-readable medium as used herein is defined to include any kind of memory, volatile or non-volatile, such as floppy disks, hard disks, CD-ROMs, flash memory, read-only memory, and random access memory.

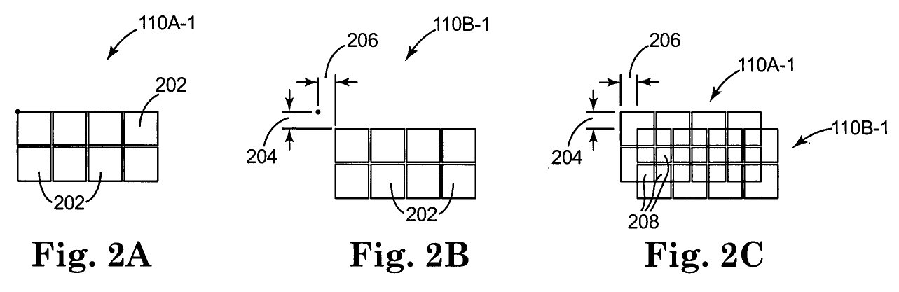

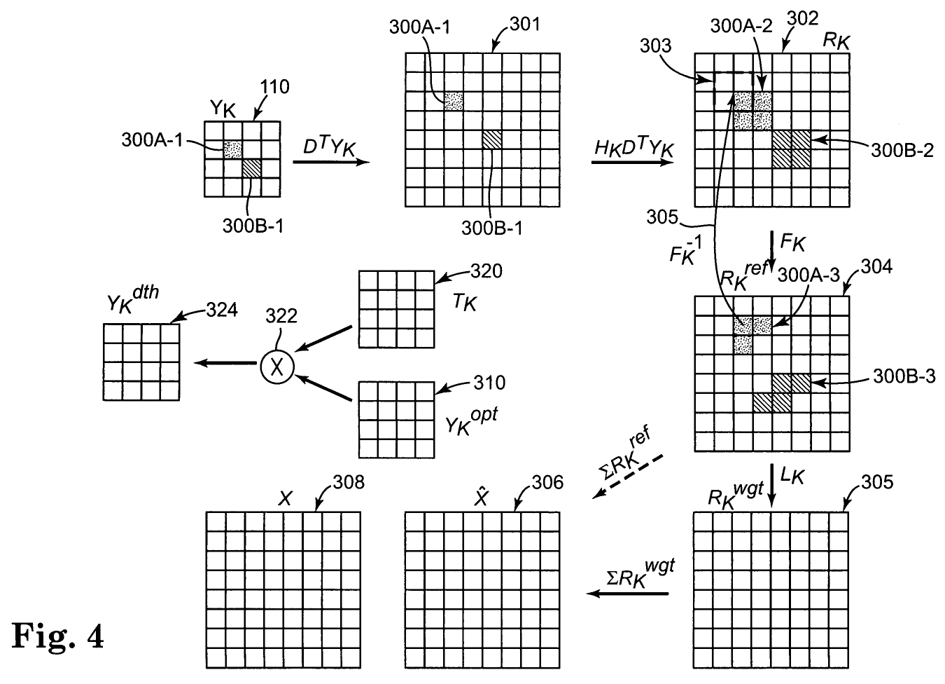

Also shown in FIG. 1 is reference projector 118 with an image frame buffer 120. Reference projector 118 is shown with hidden lines in FIG. 1 because, in one embodiment, projector 118 is not an actual projector, but rather is a hypothetical high-resolution reference projector that is used in an image formation model for generating optimal sub-frames 110, as described in further detail below with reference to FIGS. 2A-2C and 4. In one embodiment, the location of one of the actual projectors 112 is defined to be the location of the reference projector 118.

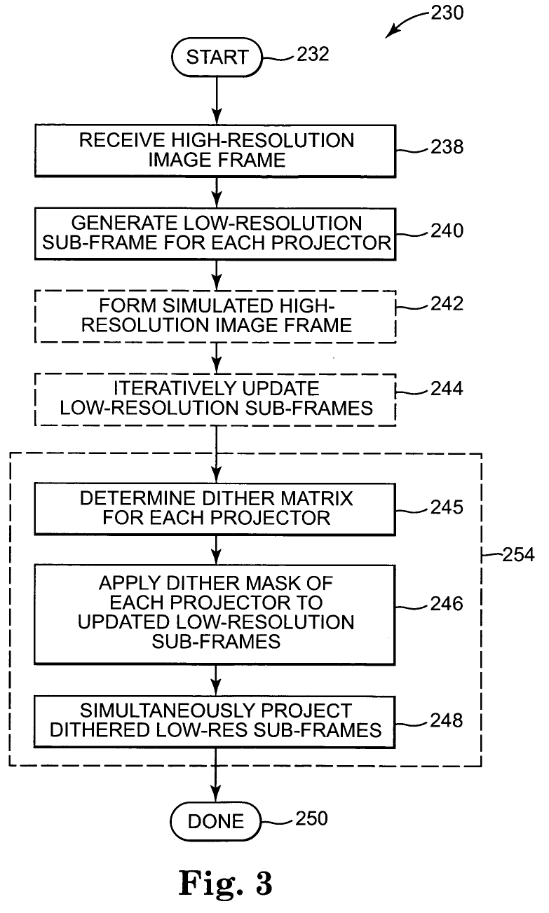

In one embodiment, display system 100 includes a camera 122 and a calibration unit 124, which are used in one form of the invention to automatically determine a geometric mapping between each projector 112 and the reference projector 118, as described in further detail below with reference to FIGS. 2A-2C and 3.

In one form of the invention, image display system 100 includes hardware, software, firmware, or a combination of these. In one embodiment, one or more components of image display system 100 are included in a computer, computer server, or other microprocessor-based system capable of performing a sequence of logic operations. In addition, processing can be distributed throughout the system with individual portions being implemented in separate system components, such as in a networked or multiple computing unit environment.

In one embodiment, display system 100 uses two projectors 112. FIGS. 2A-2C are schematic diagrams illustrating the projection of two sub-frames 110 according to one embodiment of the present invention. As illustrated in FIGS. 2A and 2B, sub-frame generator 108 defines two image sub-frames 110 for each of the image frames 106. More specifically, sub-frame generator 108 defines a first sub-frame 110A-1 and a second sub-frame 110B-1 for an image frame 106. As such, first sub-frame 110A-1 and second sub-frame 110B-1 each include a plurality of columns and a plurality of rows of individual pixels 202 of image data.

In one embodiment, as illustrated in FIG. 2B, when projected onto target 116, second sub-frame 110B-1 is offset from first sub-frame 110A-1 by a vertical distance 204 and a horizontal distance 206. As such, second sub-frame 110B-1 is spatially offset from first sub-frame 110A-1 by a predetermined distance. In one illustrative embodiment, vertical distance 204 and horizontal distance 206 are each approximately one-half of one pixel.

As illustrated in FIG. 2C, a first one of the projectors 112A projects first sub-frame 110A-1 in a first position and a second one of the projectors 112B simultaneously projects second sub-frame 110B-1 in a second position, spatially offset from the first position. More specifically, the display of second sub-frame 110B-1 is spatially shifted relative to the display of first sub-frame 110A-1 by vertical distance 204 and horizontal distance 206. As such, pixels of first sub-frame frame 110A-1 overlap pixels of second sub-frame 110B-1, thereby producing the appearance of higher resolution pixels 208. The overlapped sub-frames 110A-1 and 110B-1 also produce a brighter overall image 114 than either of the sub-frames 110 alone. In other embodiments, more than two projectors 112 are used in system 100, and more than two sub-frames 110 are defined for each image frame 106, which results in a further increase in the resolution and brightness of the displayed image 114.

In one form of the invention, sub-frames 110 have a lower resolution than image frames 106. Thus, sub-frames 110 are also referred to herein as low-resolution images or sub-frames 110, and image frames 106 are also referred to herein as high-resolution images or frames 106. It will be understood by persons of ordinary skill in the art that the terms low resolution and high resolution are used herein in a comparative fashion, and are not limited to any particular minimum or maximum number of pixels.

In one form of the invention, display system 100 produces a superimposed projected output that takes advantage of natural pixel misregistration to provide a displayed image 114 with a higher resolution than the individual sub-frames 110. In one embodiment, image formation due to multiple overlapped projectors 112 is modeled using a signal processing model. Optimal sub-frames 110 for each of the component projectors 112 are estimated by sub-frame generator 108 based on the model, such that the resulting image predicted by the signal processing model is as close as possible to the desired high-resolution image to be projected.

In one embodiment, sub-frame generator 108 is configured to generate sub-frames 110 based on the maximization of a probability that, given a desired high resolution image, a simulated high-resolution image that is a function of the sub-frame values, is the same as the given, desired high-resolution image. If the generated sub-frames 110 are optimal, the simulated high-resolution image will be as close as possible to the desired high-resolution image. The generation of optimal sub-frames 110 based on a simulated high-resolution image and a desired high-resolution image is described in further detail below with reference to FIG. 4.

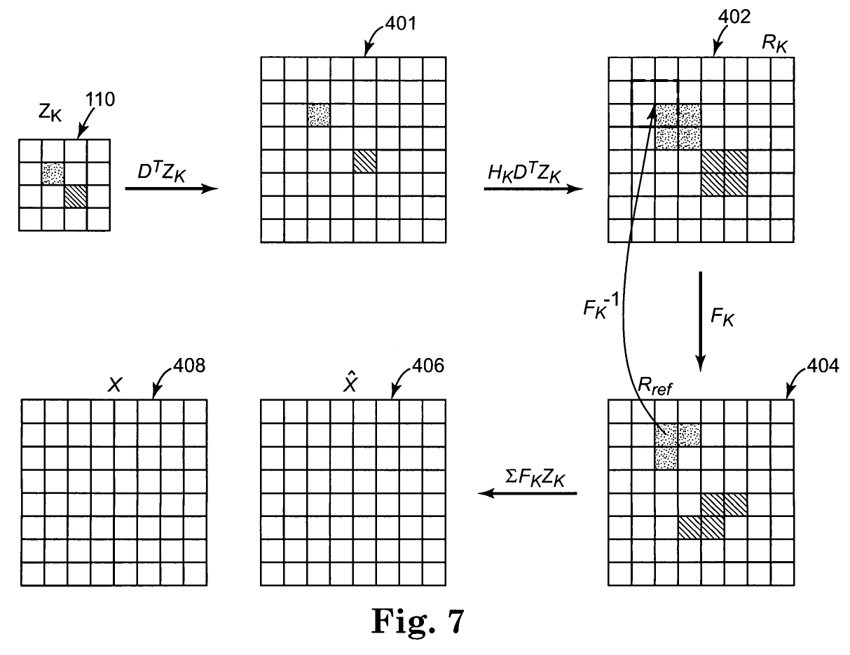

FIG. 3 is a flow diagram illustrating one embodiment of a process 230 for displaying a high-resolution image with a superimposed multi-projector display system 100 according to the present invention. Process 230 begins at 232. At 238, and as described in greater detail below with respect to FIGS. 4-5 and 7-8, the projector system 100 receives a high-resolution image frame 106 which is representative of the high-resolution image to be projected. At 240, a low-resolution sub-frame 110 is generated from the high-resolution image frame 106 for each projector based on a geometric relationship between the projector and a reference coordinate system. In one embodiment, the geometric relationship comprises a geometric operator that maps the low-resolution sub-frame to a hypothetical high-resolution grid, such as operator Fₖ described in greater detail below with respect to Equation II and FIGS. 4 and 7.

In one embodiment, process 230 proceeds directly to 245. Alternatively, in one embodiment, process 230 proceeds to 242 and 244, as described below. At 242, a simulated high-resolution image frame is formed based on the low resolution sub-frames of each of the projectors. In one embodiment, formation of the simulated high-resolution image frame includes applying a luminance profile of each projector to the corresponding low-resolution sub-frame. A description of one embodiment for determining luminance profiles for each projector is described in greater detail below with respect to FIG. 3.

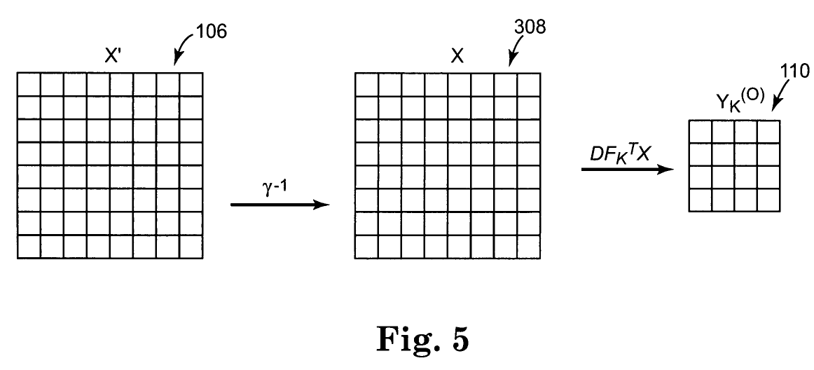

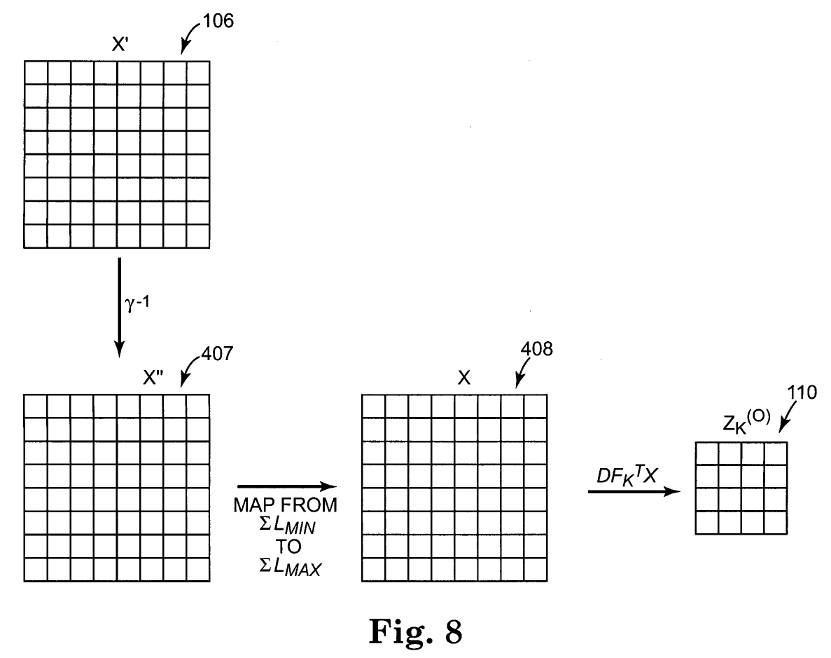

At 244, the low-resolution sub-frames of the projectors are iteratively updated based on an error between the high-resolution image frame and the simulated high-resolution image frame until a desired convergence condition is satisfied. In one embodiment, the convergence condition comprises a predetermined number of iterations. In one embodiment, the convergence condition comprises substantially minimizing the error between the high-resolution and the simulated high-resolution image frames. The iterative process of generating the low-resolution sub-frames is described in greater detail below with respect to FIGS. 4 and 7, with an initial guess for each low-resolution sub-frame being determined as described in greater detail below with respect to FIGS. 5 and 8.

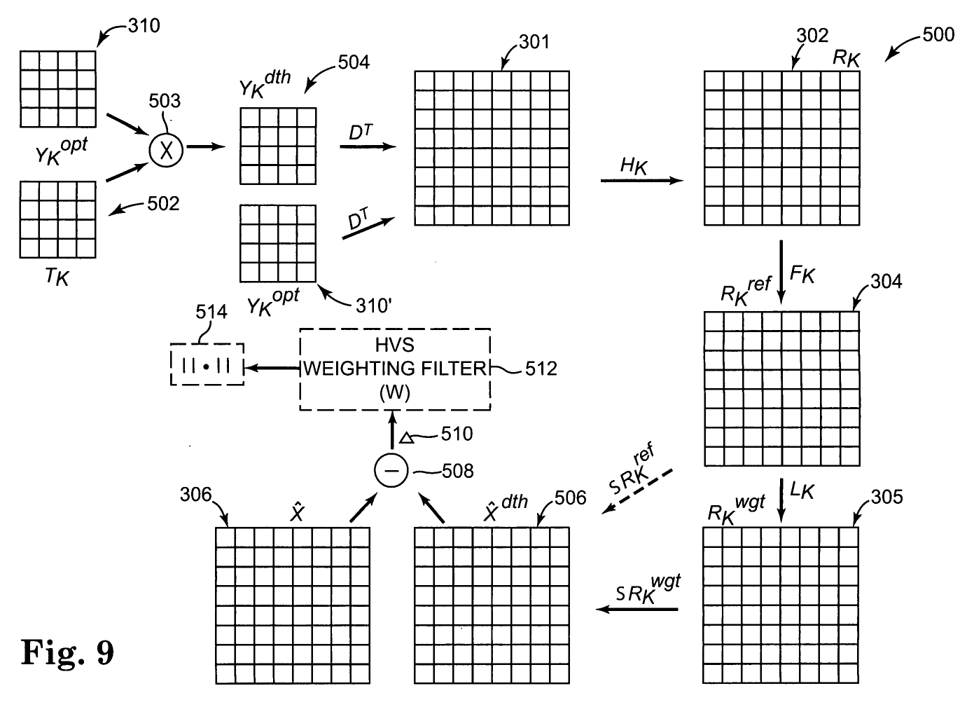

At 245, a dither array, or dither mask, is determined for each projector (e.g. projectors 112A-112C) of the multi-projector display system (e.g. multi-projector display system 100 of FIG. 1). Embodiments of processes for determining dither arrays for each of the component projectors are described below and illustrated by FIGS. 9-12. In one embodiment, again as described with respect to FIGS. 9 - 12, the luminance profiles determined at 242 are employed in the determination of the dither arrays.

At 246, the dither array (see 320 Tₖ of FIG. 4) of each projector is applied to the corresponding low-resolution sub-frame determined at 240 or to the corresponding updated low-resolution sub-frame determined at 244 to form a dithered low-resolution sub-frame for each projector. At 248, and as described above with respect to FIGS. 1 and 2A-2C, the dithered low-resolution sub-frames generated at 246 are simultaneously projected onto a target surface by the corresponding projectors, wherein the projectors are configured such that the projected dithered low-resolution sub-frames at least partially overlap on the target surface to form a projected image 114 which is substantially equal to the current high-resolution image 106.

For each additional high-resolution image frame 106, 238 through 248 are repeated to form a corresponding projected image 114 on the target surface 116. If no additional high-resolution images are to be projected, process 230 is complete, as illustrated at 250. It is noted that the determination of the luminance profile and the dither array for each component projector, as described above at 242 and 245, need only be performed once for each projector. In one embodiment, this initial determination may be performed at manufacture. In one embodiment, the luminance profile and the dither array of each component projector may be adjusted or re-calibrated after the initial determination.

As indicated at 254, in one embodiment, the processes of 245, 246, and 248 are together described as dithering the intensity levels of each low-resolution sub-frame to one of the unique intensity levels of the associated projector differently for each projector to form a dithered low-resolution sub-frame such that the dithered low-resolution sub-frames, when simultaneously projected in an overlapping fashion, form a projected image representative of the high resolution image and having a maximum number of unique projection levels substantially equal to a sum of the maximum number of unique intensity levels of all projectors of the multi-projector display system.

FIG. 4 is a diagram illustrating a model of an image formation process in accordance with one embodiment of the present invention. The sub-frames 110 (FIG. 1) are represented in the model by Yₖ, where “k” is an index for lidentifying the individual projectors 112. Thus, Y₁, for example, corresponds to a sub-frame 110A for a first projector 112A, Y₂ corresponds to a sub-frame 110B for a second projector 112B, etc. As will be described in greater detail below, the pixels of sub-frames Yₖ comprise linearized relative luminance values, the values being relative to the k^{th} projector's peak luminance. It is also noted that sub-frame Yₖ represents a “complete” frame to be projected by the k^{th} projector, but is a “sub-frame” with respect to the desired high resolution image 308(X).

Two of the sixteen pixels of the sub-frame 110 shown in FIG. 4 are highlighted, and identified by reference numbers 300A-1 and 300B-1. The sub-frames 110 (Yₖ) are represented on a hypothetical high-resolution grid by up-sampling (represented by D^{T}) to create up-sampled image 301. The up-sampled image 301 is filtered with an interpolating filter (represented by Hₖ) to create a high-resolution image 302 (Rₖ) with “chunky pixels”. This relationship is expressed in the following Equation I:

Rₖ=HₖD^{T}Yₖ Equation I
where:
   k=index for identifying the projectors 112;
   Rₖ=low-resolution sub-frame 110 of the k^{th} projector 112 on a hypothetical high-resolution grid;
   Hₖ=Interpolating filter for low-resolution sub-frame 110 from k^{th} projector 112;
   D^{T}=up-sampling matrix; and
   Yₖ=low-resolution sub-frame 110 of the k^{th} projector 112.

The low-resolution sub-frame pixel data (Yₖ) is expanded with the up-sampling matrix (D^{T}) so that the sub-frames 110 (Yₖ) can be represented on a high-resolution grid. The interpolating filter (Hₖ) fills in the missing pixel data produced by up-sampling. In the embodiment shown in FIG. 4, pixel 300A-1 from the original sub-frame 110 (Yₖ) corresponds to four pixels 300A-2 in the high-resolution image 302 (Rₖ), and pixel 300B-1 from the original sub-frame 110 (Yₖ) corresponds to four pixels 300B-2 in the high-resolution image 302 (Rₖ). The resulting image 302 (Rₖ) in Equation I models the output of the k^{th} projector 112 if there was no relative distortion or noise in the projection process.

Relative geometric distortion between the projected component sub-frames 110 is due to the different optical paths and locations of the component projectors 112. A geometric transformation is modeled with the operator, Fₖ, which maps coordinates in the frame buffer 113 of the k^{th} projector 112 to the frame buffer 120 of the reference projector 118 (FIG. 1) with sub-pixel accuracy, to generate a warped image 304 (Rₖ^{ref}). In one embodiment, Fₖ is linear with respect to pixel intensities, but is non-linear with respect to the coordinate transformations. As shown in FIG. 4, the four pixels 300A-2 in image 302 (Rₖ) are mapped to the three pixels 300A-3 in image 304 (Rₖ^{ref}), and the four pixels 300B-2 in image 302 (Rₖ) are mapped to the four pixels 300B-3 in image 304 (Rₖ^{ref}).

In one embodiment, the geometric mapping (Fₖ) is a floating-point mapping, but the destinations in the mapping are on an integer grid in image 304 (Rₖ^{ref}). Thus, it is possible for multiple pixels in image 302 (Rₖ) to be mapped to the same pixel location in image 304 (Rₖ^{ref}), resulting in missing pixels in image 304 (Rₖ^{ref}). To avoid this situation, in one form of the present invention, during the forward mapping (Fₖ), the inverse mapping (Fₖ⁻1) is also utilized as indicated at 305 in FIG. 4. Each destination pixel in image 304 (Rₖ^{ref}) is back projected (i.e., Fₖ⁻¹), as illustrated at 305, to find the corresponding location in image 302 (Rₖ). For the embodiment shown in FIG. 4, the location in image 302 (Rₖ) corresponding to the upper-left pixel of the pixels 300A-3 in image 304 (Rₖ^{ref}) is the location at the upper-left corner of the group of pixels 300A-2. In one form of the invention, the values for the pixels neighboring the identified location in image 302 (Rₖ) are combined (e.g., averaged) to form the value for the corresponding pixel in image 304 (Rₖ^{ref}). Thus, for the example shown in FIG. 4, the value for the upper-left pixel in the group of pixels 300A-3 in image 304 (Rₖ^{ref}) is determined by averaging the values for the four pixels within the frame 303 in image 302 (Rₖ).

In another embodiment of the invention, the forward geometric mapping or warp (Fₖ) is implemented directly, and the inverse mapping (Fₖ⁻¹) is not used. In one form of this embodiment, a scatter operation is performed to eliminate missing pixels. That is, when a pixel in image 302 (Rₖ) is mapped to a floating point location in image 304 (Rₖ^{ref}), some of the image data for the pixel is essentially scattered to multiple pixels neighboring the floating point location in image 304 (Rₖ^{ref}). Thus, each pixel in image 304 (Rₖ^{ref}) may receive contributions from multiple pixels in image 302 (Rₖ), and each pixel in image 304 (Rₖ^{ref}) is normalized based on the number of contributions it receives.

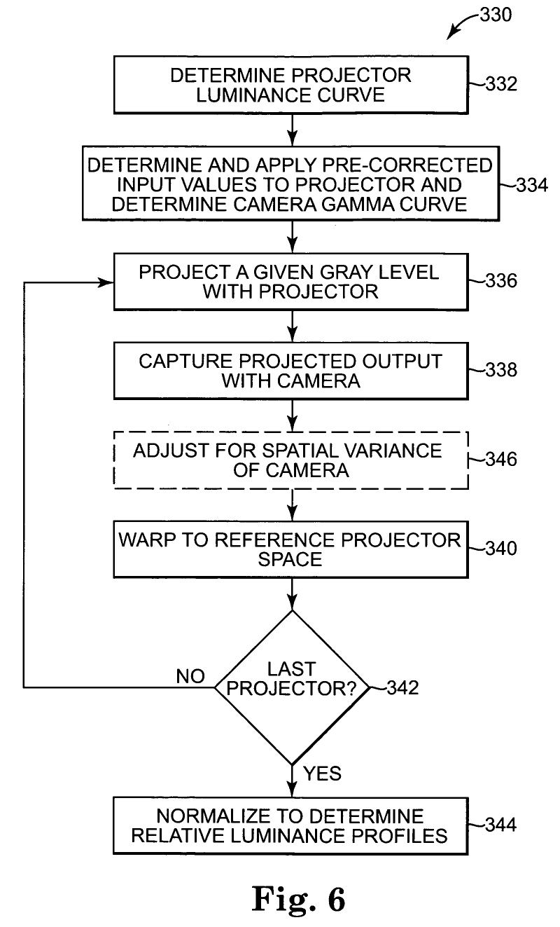

A relative luminance profile, Lₖ, models the linearized spatial luminance response of the k^{th} component projector 112 relative to the combined luminance response of all component projectors 112. The determination of relative luminance profile Lₖ is described in greater detail below with respect to FIG. 6. Relative luminance profile Lₖ is applied to warped image 304 (Rₖ^{ref}) to generate a weighted-warped image 305 (Rₖ^{wgt}) having pixel values weighted according to the relative luminance response of the k^{th} component projector 112. In this fashion, weighted-warped image 305 (Rₖ^{wgt}) accounts for luminance variations between the corresponding projected component sub-frames 110 of each of the component projectors 112.

A superposition/summation of the weighted-warped images 305 (Rₖ^{wgt}) of each the component projectors 112 forms a hypothetical or simulated high-resolution image 306 (X-hat) in the reference projector frame buffer 120, as represented in the following Equation II:

\hat{X}=ΣLₖFₖRₖ Equation II
where:
   k=index for identifying the projectors 112;
   X-hat=hypothetical or simulated high-resolution image 306 in the reference projector frame buffer 120;
   Lₖ=relative luminance profile of k^{th} projector.
   Fₖ=operator that maps a low-resolution sub-frame 110 of the kth projector 112 on a hypothetical high-resolution grid to the reference projector frame buffer 120; and
   Rₖ=low-resolution sub-frame 110 of kth projector 112 on a hypothetical high-resolution grid, as defined in Equation I.

In one embodiment, as illustrated by the dashed line in FIG. 4, relative luminance profile, Lₖ, is not employed and simulated high-resolution image 306 (X-hat) is formed from a summation of the warped image frames (Rₖ^{ref}) corresponding to each of the component projectors 112.

If the simulated high-resolution image 306 (X-hat) in the reference projector frame buffer 120 is identical to the given (desired) high-resolution image 308 (X), the system of component low-resolution projectors 112 would be equivalent to a hypothetical high-resolution projector placed at the same location as the reference projector 118 and sharing its optical path. In one embodiment, the desired high-resolution images 308 are the high-resolution image frames 106 (FIG. 1) received by sub-frame generator 108.

In one embodiment, if the simulated high-resolution image 306 (X-hat) in the reference projector frame buffer 120 deviates too far from the desired high-resolution image 308 (X), the sub-frames 110 (Yₖ) are updated iteratively according to the following Equation III:

Yₖ^{(N+1)}=Yₖ⁽ⁿ⁾+αDHₖ^{T}Fₖ^{T}Lₖ^{T}{X−\hat{X}} Equation III:
where:
   k=index for identifying the projectors 112;
   n=index for identifying the number of iterations;
   Yₖ⁽ⁿ⁺¹⁾=next low-resolution sub-frame 110 of the k^{th} projector 112;
   Yₖ⁽ⁿ⁾=present low-resolution sub-frame 110 of the k^{th} projector 112;
   X=desired high-resolution image frame 308;
   X-hat=hypothetical or simulated high-resolution image frame 306 in the reference projector frame buffer;
   α=momentum parameter indicating the fraction of error to be incorporated at each iteration;
   Lₖ^{T}=Transpose of relative luminance profile L_{k;}
   D=down-sampling matrix;
   Hₖ^{T}=Transpose of interpolating filter Hₖ from Equation I; and
   Fₖ^{T}=Transpose of operator Fₖ from Equation II (the inverse of the warp denoted by Fₖ).

In this fashion, the sub-frame 110 (Yₖ) for each component projector 112 is iteratively adjusted based on each projector's relative contribution to the simulated high-resolution image 306 (X-hat).

In one embodiment, the data of sub-frames 110 (Yₖ) for each component projector 112 is iteratively adjusted (such as described above with respect to Equation III or as described in greater detail below) until optimal sub-frame data (Yₖ*) for each of the sub-frames 110 (Yₖ) is determined which results in simulated high-resolution image 306 (X-hat) being substantially equal to desired high-resolution image 308 (X). The iteratively adjusted sub-frames comprising the optimal sub-frame data (Yₖ*) for each component projector 112 are illustrated in FIG. 4 as optimal low-resolution sub-frames 310 (Yₖ^{opt}).

According to one embodiment of the present invention, once determined, the optimal sub-frame data (Yₖ*) for each of the optimal sub-frames 310 (Yₖ^{opt}) is adjusted on a pixel-by-pixel basis by the corresponding dither array 320 (Tₖ), as indicated by operator 322, to generate a dithered sub-frame 324 (Yₖ^{dth}) for each component projector 112. Example embodiments of processes for determining dither arrays 320 (Tₖ) are described below and illustrated by FIGS. 9-12.

The dithered sub-frames 324 (Yₖ^{dth}) are then provided to the component projectors 112 for projection. However, because the luminance values of the dithered sub-frames 324 (Yₖ^{dth}) of each of the component projectors 112 comprise linearized relative values, the values cannot be input directly to the corresponding projector for projection and are gamma-corrected prior to providing the data values to the corresponding component projector 112 for projection. By employing an appropriately designed dither array 320 (Tₖ) for each of the corresponding component projectors 112, the bit-depth of overlapped projection system 100 is increased.

In one embodiment, the deviation of the simulated high-resolution image 306 (X-hat) from the desired high-resolution image 308 (X) is modeled as shown in the following Equation IV:

X=\hat{X}+η Equation IV
where:
   X=desired high-resolution frame 308;
   X-hat=hypothetical or simulated high-resolution frame 306 in the reference projector frame buffer 120; and
   η=error or noise term.

As shown in Equation IV, the desired high-resolution image 308 (X) is defined as the simulated high-resolution image 306 (X-hat) plus η, which in one embodiment represents zero mean white Gaussian noise.

The solution for the optimal sub-frame data (Yₖ*) for the sub-frames 110 is formulated as the optimization given in the following Equation V:

$${Y}_{k}^{*} = {argmax}_{{Y}_{k}} P ( \hat{X} \vert X ) \qquad Equation V$$

where:
   k=index for identifying the projectors 112;
   Yₖ*=optimum low-resolution sub-frame 110 of the kth projector 112;
   Yₖ=low-resolution sub-frame 110 of the k^{th} projector 112;
   X-hat=hypothetical or simulated high-resolution frame 306 in the reference projector frame buffer 120, as defined in Equation II;
   X=desired high-resolution frame 308; and P(X-hat|X)=probability of X-hat given X.

Thus, as indicated by Equation V, the goal of the optimization is to determine the sub-frame values (Yₖ) that maximize the probability of X-hat given X. Given a desired high-resolution image 308 (X) to be projected, sub-frame generator 108 (FIG. 1) determines the component sub-frames 110 that maximize the probability that the simulated high-resolution image 306 (X-hat) is the same as or matches the “true” high-resolution image 308 (X).

Using Bayes rule, the probability P(X-hat|X) in Equation V can be written as shown in the following Equation VI:

$$P ( \hat{X} \vert X ) = \frac{P ( X \vert \hat{X} ) P ( \hat{X} )}{P ( X )} \qquad Equation VI$$

where:
   X-hat=hypothetical or simulated high-resolution frame 306 in the reference projector frame buffer 120, as defined in Equation II;
   X=desired high-resolution frame 308;
   P(X-hat|X)=probability of X-hat given X;
   P(X|X-hat)=probability of X given X-hat;
   P(X-hat)=prior probability of X-hat; and
   P(X)=prior probability of X.

The term P(X) in Equation VI is a known constant. If X-hat is given, then, referring to Equation IV, X depends only on the noise term, η, which is Gaussian. Thus, the term P(X|X-hat) in Equation V will have a Gaussian form as shown in the following Equation VII:

$$P ( X \vert \hat{X} ) = \frac{1}{C} {e}^{\frac{{‖ X - \hat{X} ‖}^{2}}{2 {σ}^{2}}} \qquad Equation VII$$

where:
   X-hat=hypothetical or simulated high-resolution frame 306 in the reference projector frame buffer 120, as defined in Equation II;
   X=desired high-resolution frame 308;
   P(X|X-hat)=probability of X given X-hat;
   C=normalization constant; and
   σ=variance of the noise term, η.

To provide a solution that is robust to minor calibration errors and noise, a “smoothness” requirement is imposed on X-hat. In other words, it is assumed that good simulated images 306 have certain properties. The smoothness requirement according to one embodiment is expressed in terms of a desired Gaussian prior probability distribution for X-hat given by the following Equation VIII:

$$P ( \hat{X} ) = \frac{1}{Z ( β )} {e}^{- \{ {β}^{2} ( {‖ ∇ \hat{X} ‖}^{2} ) \}} \qquad Equation VIII$$

where:
   P(X-hat)=prior probability of X-hat;
   β=smoothing constant;
   Z(β)=normalization function;
   ∇=gradient operator; and
   X-hat=hypothetical or simulated high-resolution frame 306 in the reference projector frame buffer 120, as defined in Equation II.

In another embodiment of the invention, the smoothness requirement is based on a prior Laplacian model, and is expressed in terms of a probability distribution for X-hat given by the following Equation IX:

$$P ( \hat{X} ) = \frac{1}{Z ( β )} {e}^{- \{ β ( ‖ ∇ \hat{X} ‖ ) \}} \qquad Equation IX$$

where:
   P(X-hat)=prior probability of X-hat;
   β=smoothing constant;
   Z(β)=normalization function;
   ∇=gradient operator; and
   X-hat=hypothetical or simulated high-resolution frame 306 in the reference projector frame buffer 120, as defined in Equation II.

The following discussion assumes that the probability distribution given in Equation VIII, rather than Equation IX, is being used. As will be understood by persons of ordinary skill in the art, a similar procedure would be followed if Equation IX were used. Inserting the probability distributions from Equations VII and VIII into Equation VI, and inserting the result into Equation V, results in a maximization problem involving the product of two probability distributions (note that the probability P(X) is a known constant and goes away in the calculation). By taking the negative logarithm, the exponents go away, the product of the two probability distributions becomes a sum of two probability distributions, and the maximization problem given in Equation V is transformed into a function minimization problem, as shown in the following Equation X:

$${Y}_{k}^{*} = {argmin}_{{Y}_{k}} {‖ X - \hat{X} ‖}^{2} + {β}^{2} {‖ ∇ \hat{X} ‖}^{2} \qquad Equation X$$

where:
   k=index for identifying the projectors 112;
   Yₖ*=optimum low-resolution sub-frame 110 of the kth projector 112;
   Yₖ=low-resolution sub-frame 110 of the kth projector 112;
   X-hat=hypothetical or simulated high-resolution frame 306 in the reference projector frame buffer 120, as defined in Equation II;
   X=desired high-resolution frame 308;
   β=smoothing constant; and
   ∇=gradient operator.

The function minimization problem given in Equation X is solved by substituting the definition of X-hat from Equation II into Equation X and taking the derivative with respect to Yₖ, which results in an iterative algorithm given by the following Equation XI:

Yₖ^{(N+1)}=Yₖ⁽ⁿ⁾−Θ{DHₖ^{T}Fₖ^{T}|(\hat{X}⁽ⁿ⁾=X)+β²∇²\hat{X}⁽ⁿ⁾|} Equation XI
where:
   k=index for identifying the projectors 112;
   n=index for identifying iterations;
   Yₖ⁽ⁿ⁺¹⁾=low-resolution sub-frame 110 for the kth projector 112 for iteration number n+1;
   Yₖ⁽ⁿ⁾=low-resolution sub-frame 110 for the kth projector 112 for iteration number n;
   Θ=momentum parameter indicating the fraction of error to be incorporated at each iteration;
   D=down-sampling matrix;
   Hₖ^{T}=Transpose of interpolating filter, Hₖ, from Equation I (in the image domain, Hₖ^{T} is a flipped version of Hₖ);
   Fₖ^{T}=Transpose of operator, Fₖ, from Equation II (in the image domain, Fₖ^{T} is the inverse of the warp denoted by Fₖ)
   X-hat⁽ⁿ⁾=hypothetical of simulated high-resolution frame 306 in the reference projector frame buffer 120, as defined in Equation II, for iteration number n;
   X=desired high-resolution frame 308;
   β=smoothing constant; and
   ∇²=Laplacian operator.

Equation XI may be intuitively understood as an iterative process of computing an error in the reference projector 118 coordinate system and projecting it back onto the sub-frame data. In one embodiment, sub-frame generator 108 (FIG. 1) is configured to generate sub-frames 110 in real-time using Equation XI. The generated sub-frames 110 are optimal in one embodiment because they maximize the probability that the simulated high-resolution image 306 (X-hat) is the same as the desired high-resolution image 308 (X), and they minimize the error between the simulated high-resolution image 306 and the desired high-resolution image 308. Equation XI can be implemented very efficiently with conventional image processing operations (e.g., transformations, down-sampling, and filtering). The iterative algorithm given by Equation XI converges rapidly in a few iterations and is very efficient in terms of memory and computation (e.g., a single iteration uses two rows in memory; and multiple iterations may also be rolled into a single step). The iterative algorithm given by Equation XI is suitable for real-time implementation, and may be used to generate optimal sub-frames 110 at video rates, for example.

To begin the iterative algorithm defined in Equation XI, an initial guess, Yₖ^{(O)}, for the sub-frames 110 is determined. FIG. 5 is a diagram illustrating one embodiment of a process for determining initial sub-frame guess Yₖ⁽⁰⁾. An image frame 106 (X′) of the high resolution image to be displayed by image display system 100 is received by sub-frame generator 108. Typically, as illustrated, image frame 106 (X′) is received from the providing image device (e.g. a digital camera) comprising gamma-corrected (γ) pixel values. Generally, the gamma correction value of the imaging device is a known parameter and is provided as part of the image data 102. If not, an estimated gamma correction value can be determined by sub-frame generator 108. Based on the gamma value, sub-frame generator 108 performs a de-gamma operation (γ⁻¹) to form the desired high-resolution frame 308 (X) with pixels having linearized data values. In one embodiment, as illustrated by the processes of FIGS. 4 and 5, the values of high-resolution image frame 308(X) are normalized so as to comprise normalized linear luminance values ranging between values of “0” and “1.”

The initial guess, Yₖ⁽⁰⁾, for sub-frames 110 is determined from high-resolution frame 308 (X). In one embodiment, the initial guess for the sub-frames 110 is determined by texture mapping the desired high-resolution frame 308 onto the sub-frames 110. In one form of the invention, the initial guess is determined from the following Equation XII:

Yₖ⁽⁰⁾=DBₖFₖ^{T}X Equation XII
where:
   k=index for identifying the projectors 112;
   Yₖ⁽⁰⁾=initial guess at the sub-frame data for the sub-frame 110 for the kth projector 112;
   D=down-sampling matrix
   Bₖ=interpolation filter;
   Fₖ^{T}=Transpose of operator, Fₖ, from Equation II (in the image domain, Fₖ^{T} is the inverse of the warp denoted by Fₖ; and
   X=desired high-resolution frame 308.

Thus, as indicated by Equation XII, the initial guess (Yₖ⁽⁰⁾) is determined by performing a geometric transformation (Fₖ^{T}) on the desired high-resolution frame 308 (X), and filtering (Bₖ) and down-sampling (D) the result. The particular combination of neighboring pixels from the desired high-resolution frame 308 that are used in generating the initial guess (Yₖ⁽⁰⁾) will depend on the selected filter kernel for the interpolation filter (Bₖ).

In another form of the invention, as illustrated by FIG. 5, the initial guess, Yₖ⁽⁰⁾, for the sub-frames 110 is determined from the following Equation XIII:

Yₖ⁽⁰⁾=DFₖ^{T}X Equation XIII
where:
   k=index for identifying the projectors 112;
   Yₖ⁽⁰⁾=initial guess at the sub-frame data for the sub-frame 110 for the kth projector 112;
   D=down-sampling matrix
   Fₖ^{T}=Transpose of operator, Fₖ, from Equation II (in the image domain, Fₖ^{T} is the inverse of the warp denoted by Fₖ); and
   X=desired high-resolution frame 308.

Equation XIII is the same as Equation XII, except that the interpolation filter (Bₖ) is not used.

Several techniques are available to determine the geometric mapping (Fₖ) between each projector 112 and the reference projector 118, including manually establishing the mappings, or using camera 122 and calibration unit 124 (FIG. 1) to automatically determine the mappings. In one embodiment, if camera 122 and calibration unit 124 are used, the geometric mappings between each projector 112 and the camera 122 are determined by calibration unit 124. These projector-to-camera mappings may be denoted by Tₖ, where k is an index for identifying projectors 112. Based on the projector-to-camera mappings (Tₖ), the geometric mappings (Fₖ) between each projector 112 and the reference projector 118 are determined by calibration unit 124, and provided to sub-frame generator 108. For example, in a display system 100 with two projectors 112A and 112B, assuming the first projector 112A is the reference projector 118, the geometric mapping of the second projector 112B to the first (reference) projector 112A can be determined as shown in the following Equation XIV:

F₂=T₂T₁⁻¹ Equation XIV
where:
   F₂=operator that maps a low-resolution sub-frame 110 of the second projector 112B to the first (reference) projector 112A;
   T₁=geometric mapping between the first projector 112A and the camera 122; and
   T₂=geometric mapping between the second projector 112B and the camera 122.

In one embodiment, the geometric mappings (Fₖ) are determined once by calibration unit 124, and provided to sub-frame generator 108. In another embodiment, calibration unit 124 continually determines (e.g., once per frame 106) the geometric mappings (Fₖ), and continually provides updated values for the mappings to sub-frame generator 108.

FIG. 6 is a flow diagram illustrating one embodiment of a process 330 for determining relative luminance profiles Lₖ (as employed by Equation II above) for the component projectors 112 of image display system 100 according to the present invention. Process 330 begins at 332 where the luminance curve (i.e. gamma) of a selected one of the component projectors 112 is determined. In one embodiment, the luminance curve is determined by providing a series of known input values to the selected projector and measuring the selected projector's output luminance. Based on the non-linear output of the selected projector in response to the series of known input values, the luminance curve (i.e. gamma correction) of the selected projector is determined.

At 334, an inverse of the luminance curve determined above at 332 is applied to a series of input values to generate a series of pre-corrected input values. The series of pre-corrected input values are applied to the selected projector such that the selected projector functions as a linearized light projection device. The luminance output of the selected projector in response to the series of pre-corrected input values is captured with a digital camera or other suitable image capturing device. Based on the image data values captured by the camera at each of the pre-corrected input values, the gamma curve of the camera is determined.

In one embodiment, the luminance curve of each of the component projectors 112 is determined and each projector is employed to project a same series of pre-corrected data values. The corresponding luminance values captured by the camera are then integrated to determine the gamma curve (at 334) of the camera to thereby reduce potential effects resulting from noise.

At 336, data values representative of a selected gray level are applied to and projected by a first component projector 112 of the imaging system 100. At 338, the projected output of the component projector 112 in response to the selected gray level input is captured by the camera. The gamma curve of the camera, as determined at 334, is applied to the captured luminance values to linearize the captured luminance values.

Process 330 proceeds to 340 where the linearized luminance values are “warped” to the high-resolution grid, which is also referred to herein as projector space. Generally, the resolution of the camera does not match the resolution of the high-resolution image which is desired to be projected, with the number of pixels of the image captured by the camera generally being less than the number of pixels of the desired high resolution image. As such, at 340, an up-sampling matrix, an interpolating filter, and a geometric mapping (similar to Fₖ, Hₖ, and D^{T} described above by Equations I and II with respect to formation of images Rₖ and R_{ref}) are applied to the output data captured by the camera to expand and map (commonly referred to as “warping”) the captured image to the high-resolution grid and generate an absolute linear luminance profile (Lₖ′) for the component projector 112. Alternatively, a texture mapping method, as is well-known in the art, can be employed to map the output data captured by the camera from the coordinate system of the camera to the coordinate system of the desired high resolution image.

At 342, process 330 queries whether the projector whose absolute linear luminance profile L′ₖ was just determined at 340 is the final component projector 112 of image display system 100. If the answer to the query is “no”, process 330 returns to 336 and repeats 336 through 340 to determine the absolute linear luminance profile L′ₖ of the next component projector 112 of image display system 100.

If the answer to the query at 342 is “yes”, process 330 proceeds to 344 where the absolute linear luminance profile, Lₖ, of each of the component projectors 112 are normalized across space to determine the relative luminance profile (Lₖ) for each component projector 112. The relative luminance profile, Lₖ, for each projector is employed as described above with respect to FIG. 4 to determine an optimal sub-frame Yₖ for each component projector 112 such that the summation of the sub-frames Yₖ of all projectors 112 (as described by Equation II above) is substantially equal to the desired high-resolution image 308 (X).

In one embodiment of process 330, in lieu of warping the output data captured by the camera “up to” the high-resolution grid at 340, the absolute linear luminance profile, Lₖ′, for each component projector 112 is formed by warping the output data captured by the camera “down to” the low-resolution sub-frame coordinate system. The absolute linear luminance profiles, Lₖ′, are then normalized at 344 such that the relative luminance profile, Lₖ, for each component projector 112 is with respect to the low-resolution sub-frame coordinate system in lieu of the high-resolution grid. In such an embodiment, with reference to FIG. 4, the relative luminance profile, Lₖ, is applied to low-resolution sub-frame (Y_{K}) 110 prior to up-sampling matrix, D^{T}, as part of the process to form up-sampled image 301 rather than being applied to image 304 (Rₖ^{ref}). Additionally, Equation III is modified such that relative luminance profile, Lₖ, is applied subsequent to down-sampling matrix, D, rather than being applied prior to the Fₖ^{T} operator.

In one embodiment, as illustrated at 346, process 330 adjusts the luminance values captured by the camera at 338 to compensate for any spatial variance that may exist in the camera's image sensor. Similar to the spatial variance described above with respect to component projectors 112, there may also be a spatial variance across the camera's image sensor. In one embodiment, to determine the camera's spatial variance, a known “flat-field” luminance field is provided and captured with the camera. The luminance values captured by the camera in response to the known flat-field are then linearized using the camera's gamma curve, as determined at 334 above, to determine an absolute linear spatial variance (V_{C}) of the camera. At 346, an inverse of the absolute linear spatial variance (V_{C}⁻¹) of the camera is applied to the linearized luminance values determined at 338 to adjust for any spatial variance contributions of the camera. These adjusted linearized luminance values are then “warped” to a desired reference grid or coordinate system as described at 340.

In one embodiment of the present invention, as illustrated by FIGS. 7 and 8 below, sub-frame generator 108 is configured to generate sub-frames (Zₖ) comprising absolute linearized luminance values in lieu of sub-frames (Yₖ) comprising relative linearized luminance values (as described above with respect to FIGS. 4 and 5).

At least a portion of projected light from each of the component projectors 112 results from ambient light contributions, which is in addition to light projected in response to received image data. As such, due to ambient light, a certain amount of light will be projected by each component projector 112 of image display system 100 even when in an “off” state. During operation, such ambient light contributions can affect the quality of the projected image.

As such, in one embodiment of the present invention, a process similar to that for determining the relative luminance profile, Lₖ, for each component projector 112 as described above with respect to FIG. 6 is employed to determine an ambient luminance profile, L_{A}, for image display system 100. To determine the ambient luminance profile, L_{A}, each of the component projectors 112 of display system 100 is turned off and a digital camera (such as described above by process 330 of FIG. 6) is employed to capture ambient light projected onto target surface 116 (see FIG. 1). The captured image is then “warped-up” to the high-resolution grid to form an absolute ambient luminance profile, L_{A}′, for the system. The absolute ambient luminance profile, L_{A}′, is translated to linear data values to form ambient luminance profile L_{A} for the system.

In one embodiment, with respect to FIG. 5, the ambient luminance profile, L_{A}, is subtracted from the linearized data values of the desired high-resolution image 308 (X) prior to the linearized data values being normalized. During projection of image 114 corresponding to high-resolution image frame 308 (X), the ambient light contributions are inherently included as part of the projected image.

FIG. 7 is a diagram illustrating a model of an image formation process for modeling sub-frames 110, wherein the sub-frames 110 comprise absolute linearized luminance values represented as sub-frames 110 (Zₖ), where “k” is an index for identifying the individual component projectors 112. Thus, Z₁, for example, corresponds to a sub-frame for a first projector 112A, Z₂ corresponds to a sub-frame 110B for a second projector 112B, etc.

The image formation process for modeling sub-frames 110 (Zₖ) is similar to that for generating sub-frames Yₖ as described above with respect to FIG. 4. As such, sub-frames 110 (Zₖ) are represented on a hypothetical high-resolution grid by up-sampling (represented by D^{T}) to create an up-sampled image 401. The up-sampled image 401 is filtered with an interpolating filter (represented by Hₖ) to create a high-resolution image 402 (Rₖ) with “chunky” pixels. This relationship is expressed in a fashion similar to that expressed above by Equation I. In a fashion similar to that described above with respect to FIG. 4, a geometric transformation (Fₖ) is modeled which maps coordinates in the frame buffer 113 of the k^{th} projector 112 to a warped image 404 (R_{ref}).

In a fashion similar to that described above by Equation II, a summation of the warped images 404 (R_{ref}) of each of the component projectors 112 forms a hypothetical or simulated-high resolution image 406 (X-hat). However, unlike Equation II and the image formation process of FIG. 4, since the values of sub-frames Zₖ are in terms of absolute linearized luminance values, the values of warped images 404 (R_{ref}) are not “weighted” by a relative luminance profile Lₖ, prior to their summation to form simulated high-resolution image 406 (X-hat).

If the simulated high-resolution image 406 (X-hat) in the reference projector frame buffer 120 is identical to the given (desired) high-resolution image 408 (X), the system of component low-resolution projectors 112 would be equivalent to a hypothetical high-resolution projector placed at the same location, as the reference projector 118 and sharing its optical path. In one embodiment, the desired high-resolution images 408 are the high-resolution image frames 106 (FIG. 1) received by sub-frame generator 108.

In one embodiment, if the simulated high-resolution image 406 (X-hat) in the reference projector frame buffer 120 deviates too far from the desired high-resolution image 408 (X), an iterative process (similar to that described above by Equation III) is employed to determine values for sub-frames 110 (Zₖ) which will form desired high-resolution image 408(X). In one embodiment, this iterative process is represented by the following Equation XV:

Zₖ⁽ⁿ⁺¹⁾=Zₖ⁽ⁿ⁾+αDHₖ^{T}Fₖ^{T}{X−\hat{X}} Equation XV:
where:
   k=index for identifying the projectors 112;
   n=index for identifying the number of iterations;
   Zₖ⁽ⁿ⁺¹⁾=next low-resolution sub-frame 110 of the k^{th} projector 112;
   Zₖ⁽ⁿ⁾=present low-resolution sub-frame 110 of the k^{th} projector 112;
   X=desired high-resolution image frame 408;
   X-hat=hypothetical or simulated high-resolution image frame 406 in the reference projector frame buffer;
   α=momentum parameter indicating the fraction of error to be incorporated at each iteration
   D=down-sampling matrix
   Hₖ^{T}=Transpose of interpolating filter Hₖ from Equation I; and
   Fₖ^{T}=Transpose of the operation Fₖ from Equation II (the inverse of the warp denoted by Fₖ).

### In this fashion, the sub-frame 110 (Zₖ) for each component projector 112 is iteratively adjusted based on each projector's absolute linearized luminance contribution to the simulated high-resolution image 406 (X-hat).

Since the values of the sub-frames Zₖ of each of the component projectors 112 comprise linearized absolute luminance values, sub-frames Zₖ cannot be directly provided to the corresponding projector for projection. As such, when the simulated high-resolution image 406 (X-hat) is determined to be substantially equal to the desired high-resolution image 408 (X), the values of sub-frames Zₖ are translated or mapped to provide data values for projection by the corresponding component projector 112 based on the projector's luminance curve (i.e. gamma curve). In one embodiment, this mapping or translation is represented by the following Equation XVI:

Zₖ′=Pₖ⁻¹Zₖ Equation XVI
where:
   k=index for identifying component projectors 112;
   Zₖ′=low-resolution sub-frame 110 of the k^{th} projector 112 on a hypothetical high-resolution grid (gamma-corrected data values);
   Pₖ⁻¹=operator that maps linear absolute luminance values to a data values for projection by the k^{th} projector; and
   Zₖ=low-resolution sub-frame 110 of the k^{th} projector 112 (linear absolute luminance values).

In one embodiment, the operator Pₖ⁻¹ is based on the gamma curve, and on an absolute linear luminance profile corresponding to the k^{th} projector, similar to the luminance curve and absolute linear luminance profile Lₖ as described respectively at 332 and 344 by process 330 of FIG. 6. In one embodiment, the absolute linear luminance profile L′ₖ is determined with the gray level of each projector substantially at a highest gray level output of the k^{th} projector.

To begin the image formation process described above by FIG. 7, an initial guess, Zₖ⁽⁰⁾, for the sub-frames 110 is determined. FIG. 8 is a diagram illustrating one embodiment of a process for determining initial sub-frame guess Zₖ⁽⁰⁾. An image frame 106 (X′) of the high resolution image to be displayed by image display system 100 is received by sub-frame generator 108. Typically, as illustrated, image frame 106 (X′) is received from the providing image device (e.g. a digital camera) comprising gamma-corrected (γ) pixel values. Generally, the gamma correction value of the providing imaging is a known parameter and is provided as part of the image data 102. If not, an estimated gamma correction value can be determined by sub-frame generator 108.

Based on the gamma value, sub-frame generator 108 performs a de-gamma operation (γ⁻¹) to form the desired high-resolution frame 407 (X″) with pixels having linearized data values. The linearized data values of frame 407 (X″) are mapped to absolute linear luminance values within the full luminance range of the component projectors 112 (from ΣL_{MIN} to ΣL_{MAX}, as described above) to form a desired high-resolution image frame 408 (X).

In one embodiment, the linearized data values of each pixel of frame 407 (X″) are mapped with respect to a full luminance range of each pixel of the projector system. In one embodiment, the linearized data values of each pixel of frame 407 (X″) are mapped with respect to a full luminance range of all pixels of the projector system such that the relative “brightness” of the pixels with respect to one another remains the same. In one embodiment, in a fashion similar to that described above with regard to the process of FIGS. 3 and 4, the absolute ambient luminance profile, L_{A}′, is subtracted from high-resolution image frame 408(X) in order to compensate for ambient light contributions.

The initial guess, Zₖ⁽⁰⁾, for sub-frames 110 is determined from desired high-resolution frame 408 (X). In one embodiment, the initial guess for the sub-frames 110 is determined by texture mapping the desired high-resolution frame 408 onto the sub-frames 110. In one form of the invention, the initial guess is determined in a fashion similar to the described above by Equation XII. In one embodiment, the initial guess is determined in a fashion similar to that described above by Equation XIII.

Techniques for determining dither arrays (Tₖ) for component projectors 112 of overlapped image display system 100 are described below with respect to FIGS. 9-12. Dithering may be defined or thought of as a process of juxtaposing pixels of two color or gray levels to create the illusion that a third level is present such that a display device is able to display an image having, or at least the appearance of having, more color or gray levels than the number of unique gray or color levels actually available from the display device.

One dithering technique, sometimes referred to as an “ordered” dithering, employs a dither array or matrix composed of dither values corresponding to the unique levels of the display device and which are arranged in a particular pattern (e.g. Hilbert pattern). A pixel level of an image to be displayed is compared to a dither level at a corresponding position in the dither array and the pixel level is adjusted or “dithered” to one of the unique available projection levels based on the comparison. Each pixel is compared to only one value in the dither array. If the size of the image to be displayed is greater than the size of the dither array, some methods “tile” the smaller dither array across the image so as to dither the entire image.

As an example, consider an image having 512 gray levels (i.e. a 9-bit image having unique levels ranging from 0 to 511) to be displayed by a display device, such as a projector, capable of providing 256 unique levels (i.e. an 8-bit device). In one instance, the 256 unique levels of the projector are assigned to those of the image such that the projector provides 256 unique levels ranging between 0 and 512 (e.g. 0, 2, 4, . . . , 510). The upper and lower bounds of each of the 512 image levels are determined based on the number of unique levels available from the projector. For example, a pixel having a level of 5 has lower and upper bounds of 4 and 6 with respect to the 256 unique projection levels. A dither array having 256 values corresponding to the unique levels of the projector (e.g. 0, 2, 4, . . . , 510) is employed to select between the upper and lower bounds for each pixel of the image. As an example, if a pixel has a value of “295” and a dither value at the corresponding position in the dither array is “200”, the upper bound (i.e. “296”) is selected as the pixel's “dithered” value. However, if the dither value at the corresponding position in the dither array is “300” rather than “200”, the lower bound (i.e. “294”) is selected as the pixel's dithered value.

With regard to the overlapping or superimposed multi-projector image display system of one embodiment of the present invention, such as image display system 100 of FIG. 1, employing jointly designed and unique dither arrays for each projector as described herein (in lieu of using a same dither array for each projector) increases the bit-depth of display system 100. As an example, consider an instance where display system 100 comprises two projectors. If the image pixel has a level of “3”, for instance, and the projectors provide levels of “2” and “4”, merely quantizing (e.g. using a same dither array for both projectors) results in both projectors displaying a “2” or both projectors displaying a “4”, thereby resulting in an error. However, by employing jointly designed dither arrays as described herein, the values of the low-resolution sub-frames 110 (Yₖ) for each component projector 112 may be dithered such that one projects a level of 2 and the other projects a level of 4 (i.e. a level of 6 of 511), resulting in an average equal to the desired level of 3.

As such, by employing jointly designed dither arrays for each of the component projectors of an overlapping projection system in accordance with one embodiment of the present invention, the bit-depth of the projection system can be increased. For example, a multi-projector system employing two M-bit projectors is able to project up to 2(2^{M})−1 unique levels. For instance, two superimposed 8-bit projectors are able to project up to 511 unique levels.

FIG. 9 illustrates generally one embodiment of a process 500 for determining a dither array for a projector of a multi-projector system (e.g. projector 112 of image display system 100 of FIG. 1) employing an image formation process similar to that described above with respect to FIG. 4. Although not explicitly illustrated by FIG. 9, process 500 begins with generating optimal low-resolution sub-frames 310 (Yₖ^{opt}) for each component projector 112 using an image formation model, such as that illustrated by the image formation model of FIG. 4, for a desired high-resolution image frame 308 (X) (see FIGS. 4 and 5). As described above, the optimal low-resolution sub-frames 310 (Yₖ^{opt}) are those sub-frames that result in the image formation model generating a simulated high-resolution image frame 306 (X-hat) being substantially equal to desired high-resolution image frame 308 (X). In one embodiment, the desired high-resolution image frame 308 (X) serves as a “training” image and is selected so as to have certain desirable characteristics (e.g. broad ranges of colors and intensity levels).

A dither array 502 (Tₖ) for a selected one of the component projectors 112 (e.g. component projector 112A) is applied to the corresponding optimal low-resolution sub-frames 310 (Yₖ^{opt}), as indicated by an operator 503, to generate a dithered low-resolution sub-frame 504 (Yₖ^{dth}) for the selected component projector. In one embodiment, as described above, dither array 502 (Tₖ) includes dither or threshold values corresponding to each of the unique levels which can be displayed by the selected one of the component projectors, with the dither values being arranged in a desired pattern. In one embodiment, the desired pattern is initially a random pattern, with the desired pattern subsequently being iteratively updated as described in greater detail below. With regard to process 500, applying dither array 502 (Tₖ) to the corresponding low-resolution sub-frames 310 (Yₖ^{opt}) includes comparing each value of low-resolution sub-frame 310 (Yₖ^{opt}) to a corresponding value in dither array 502 (Tₖ) in a fashion similar to the “ordered” dithering process described above.

In one embodiment, where the selected component projector is an M-bit projector, dither array 502 (Tₖ) includes 2^{M} unique dither values. In one embodiment, the size of dither array 502 (Tₖ) matches the size of the corresponding optimal low-resolution sub-frames 310 (Yₖ^{opt}) and includes multiple entries of each of the dither values. For example, where the optimal low-resolution sub-frame 310 (Yₖ^{opt}) is a 1024×768 frame and the selected component projector is an 8-bit projector (i.e. 256 unique levels), dither array 502 (Tₖ) is a 1024×768 array and includes 3,072 dither entries for each of the 256 unique dither values (e.g. 0, 1, 2, . . . , 255), which are arranged in a desired pattern. In one embodiment, dither array 502 (Tₖ) is smaller in size and is “tiled” across optimal low-resolution sub-frame 310 (Yₖ^{opt}).

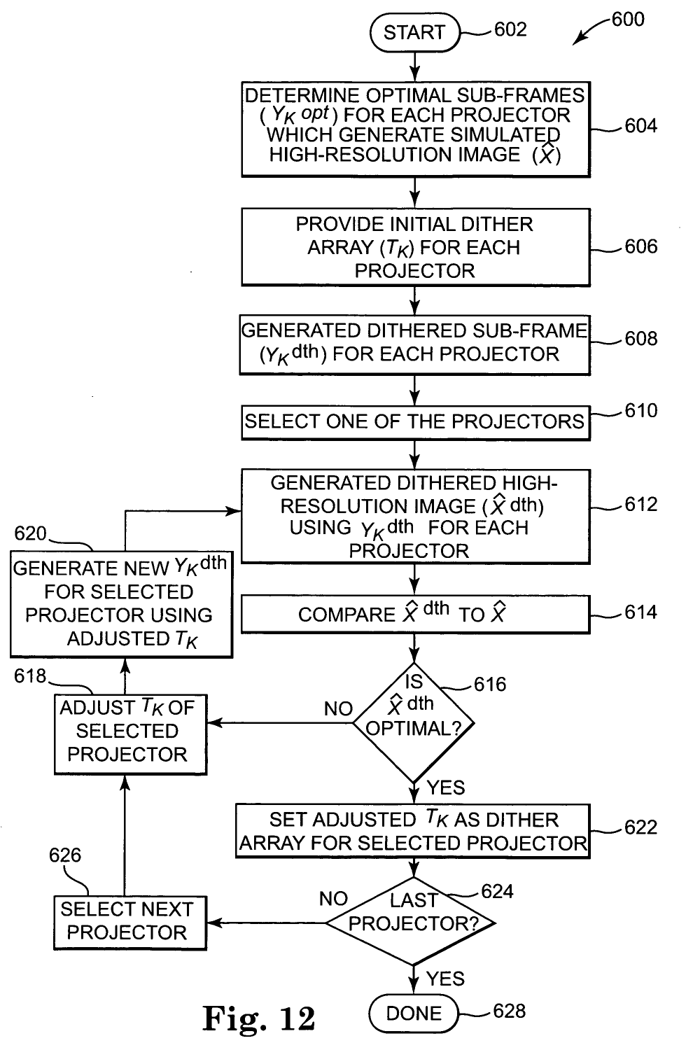

An image formation model, such as the image formation model of FIG. 4, is then employed to generate a dithered high-resolution image 506 (X-hat^{dth}). In one embodiment, as illustrated by FIG. 9, dithered low-resolution sub-frame 504 (Yₖ^{dth}) of the selected component projector and the optimal low-resolution sub-frames 310′ (Yₖ^{opt}) of the remaining component projectors (e.g. 112B, 112C, etc.) are employed to generate up-sampled image 301. In one embodiment, as described in greater detail below with respect to FIG. 12, dithered low-resolution sub-frames 504 (Yₖ^{dth}) for each of the component projectors are employed to generate dithered high-resolution image 506 (X-hat^{dth}), in lieu of using the dithered low-resolution sub-frame 504 (Yₖ^{dth}) for only the selected component projector 112.

Generation of up-sampled image 301, high-resolution image 302 (Rₖ), warped image 304 (Rₖ^{ref}), and weighted-warped image 305 (Rₖ^{wgt}) are performed in a fashion similar to that described above with respect to FIG. 4 to generate dithered high-resolution image 506 (X-hat^{dth}). In one embodiment, dithered high-resolution image 506 (X-hat^{dth}) is the summation of the weighted-warped image 305 (Rₖ^{wgt}) of each component projector 112. In one embodiment, as described above and as illustrated by the dashed line, luminance profiles Lₖ are not employed, and dithered high-resolution image 506 (X-hat^{dth}) is the summation of the warped image 304 (Rₖ^{ref}) of each component projector 112.

In one embodiment, as illustrated, dithered high-resolution frame 506 (X-hat^{dth}) is compared to simulated high-resolution image frame 306 (X-hat) which is generated using optimal low-resolution sub-frames 310′ (Yₖ^{opt}) for each component projector 112, including the selected component projector. When the dithered low-resolution sub-frame 504 (Yₖ^{dth}) of the selected component projector is optimized, the dithered high-resolution frame 506 (X-hat^{dth}) formed by dithered low-resolution sub-frame 504 (Yₖ^{dth}) of the selected projector and the optimal low-resolution sub-frames 310 (Yₖ^{opt}) of the remaining component projectors will be as close as desired (e.g. within an acceptable error) to simulated high-resolution image frame 306 (X-hat). Various error metrics may be employed to determine how close dithered high-resolution frame 506 (X-hat^{dth}) is to simulated high-resolution image frame 306 (X-hat), such as, for example, mean square error and weighted mean square error techniques.

In one embodiment, similar to that described above with respect to simulated high-resolution image frame 306 (X-hat) and desired high-resolution image frame 308 (X), if dithered high-resolution frame 506 (X-hat^{dth}) deviates too far from simulated high-resolution image frame 306 (X-hat), the pattern of dither or threshold values of dither array 502 (Tₖ) is iteratively adjusted based on the determined error until an optimal dither array 502 (Tₖ) is determined that results in dithered high-resolution frame 506 (X-hat^{dth}) being as close as possible to simulated high-resolution image frame 306 (X-hat) (see 320 (Tₖ) of FIG. 4).

Various techniques may be employed to efficiently adjust the pattern of dither or threshold values of dither array 502 (Tₖ), such as, for example, swap and toggle techniques. One example of a mean-preserving dither matrix is described by the following publications: R. Ulichney, “Method of Increasing Apparent Amplitude Resolution and Correcting Luminance Non-Uniformity in Projected Displays”, IEEE International Workshop on Projector-Camera Systems (PROCAMS-2003); and R. Ulichney, “Halftoning”, Wiley Encyclopedia of Electrical and Electronic Engineering, Vol. 8, pp. 588-600, John Wiley and Sons, Inc., 1999, each of which are herein incorporated by reference.

In one embodiment, dithered high-resolution frame 506 (X-hat^{dth}) is subtracted on a pixel-by-pixel basis from the simulated high-resolution image frame 306 (X-hat) at a subtraction stage 508. In one embodiment, the resulting image error data (Δ) 510 is filtered by a human visual system (HVS) weighting filter (W) 512. In one embodiment, HVS weighting filter (W) 512 filters error image data (Δ) 510 based on characteristics of the human visual system. In one embodiment, (HVS) weighting filter (W) 512 reduces or eliminates low-frequency errors (to which the human visual system is most sensitive). The mean squared error of the filtered data is then determined at a stage 514 to provide a measure of how close dithered high-resolution frame 506 (X-hat^{dth}) is to simulated high-resolution image frame 306 (X-hat).

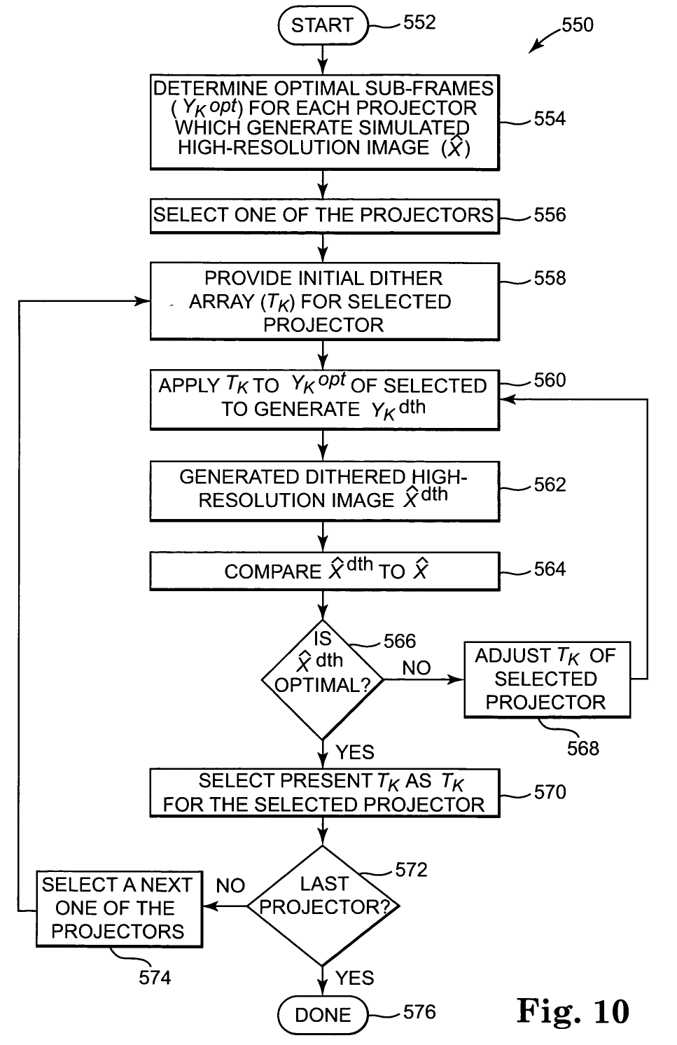

FIG. 10 is a flow diagram illustrating one embodiment of a process 550 for determining dither arrays for component projectors of a multi-projector display, such as component projectors 112 of image display system 100. Process 550 begins at 552. At 554, in a fashion similar to that described above with respect to FIG. 4, optimal sub-frames 310 (Yₖ^{opt}) are determined for each component projector 112 which generate simulated high resolution image 306 (X-hat) which is substantially equal to a selected high resolution image 308 (X). As described above, in one embodiment, selected high resolution image 308 (X) is selected to have certain desirable attributes (e.g. wide color and intensity range, etc.).

At 556, one projector of the component projectors 112 is selected, such as component projector 112A, for example. At 558, dither array 502 (Tₖ) having an initial dither pattern is determined for the selected component projector 112. In one embodiment, the initial dither pattern is a random pattern. At 560, dither array 502 (Tₖ) is applied to the optimal sub-frame 310 (Yₖ^{opt}) of the selected component projector 112 to generate dithered sub-frame 504 (Yₖ^{dth}) for the selected component projector. Initially, dither array 502 (Tₖ) will have an initial dither pattern (e.g. random pattern) as determined at 558, but will otherwise have a dither pattern as adjusted at 568 below.

At 562, an image formation model such as described above with respect to FIG. 9, generates a dithered high-resolution image 506 (X-hat^{dth}) based on the dithered low-resolution sub-frame 504 (Yₖ^{dth}) of the selected component projector and the optimal low-resolution sub-frames 310′(Yₖ^{opt}) of the remaining component projectors. At 564, the dithered high-resolution image 506 (X-hat^{dth}) is compared to simulated high resolution image 306 (X-hat) determined at 554, and it is queried at 566 whether dithered high-resolution image 506 (X-hat^{dth}) is optimal.

If the answer to the query at 566 is “no”, process 550 proceeds to 568 where the dither pattern of dither array 502 (Tₖ) is adjusted based on an error between dithered high-resolution image 506 (X-hat^{dth}) and simulated high resolution image 306 (X-hat), such as described above with respect to FIG. 9. After adjusting the dither pattern of dither array 502 (Tₖ), process 550 returns to 560, where 560 through 566 are repeated. As described above with respect to FIG. 9, various techniques may be employed to efficiently adjust the pattern of dither or threshold values of dither array 502 (Tₖ), such as, for example, swap and toggle techniques.

If the answer to the query at 566 is “yes”, process 550 proceeds to 570 where the present dither array 502 (Tₖ) is selected as the dither array for the selected one of the component projectors 112 (e.g component projector 112A). In one embodiment, the present dither array 502 (Tₖ) is selected as the dither array for the selected one of the component projectors 112 and stored at a memory therein. At 572, process 550 queries whether a dither array has been determined for each of the projectors of the multi-projector display system. If the answer to the query at 572 is “no”, process 550 proceeds to 574 where a next one of the component projectors 112 is selected and returns to 558. If the answer to the query at 572 is “yes”, process 550 is complete, as illustrated at 576.

With regard to process 550, it is noted that the dither array 502 (Tₖ) of each component projector 112 is independently calculated. In other words, when determining dither array 502 (Tₖ) for a selected component projector 112, the dither array 502 (Tₖ) for only the selected projector 112 is employed to form a corresponding dithered low-resolution sub-frame 504 (Yₖ^{dth}), so that the dithered high-resolution image 506 (X-hat^{dth}) is formed based on the dithered low-resolution sub-frame 504 (Yₖ^{dth}) of the selected component projector and the optimal low-resolution sub-frames 310′(Yₖ^{opt}) of the remaining, non-selected, component projectors 112. As such, a dither array 502 (Tₖ) of one component projector 112 does not affect the determination of a dither array 502 (Tₖ) of another component projector 112.

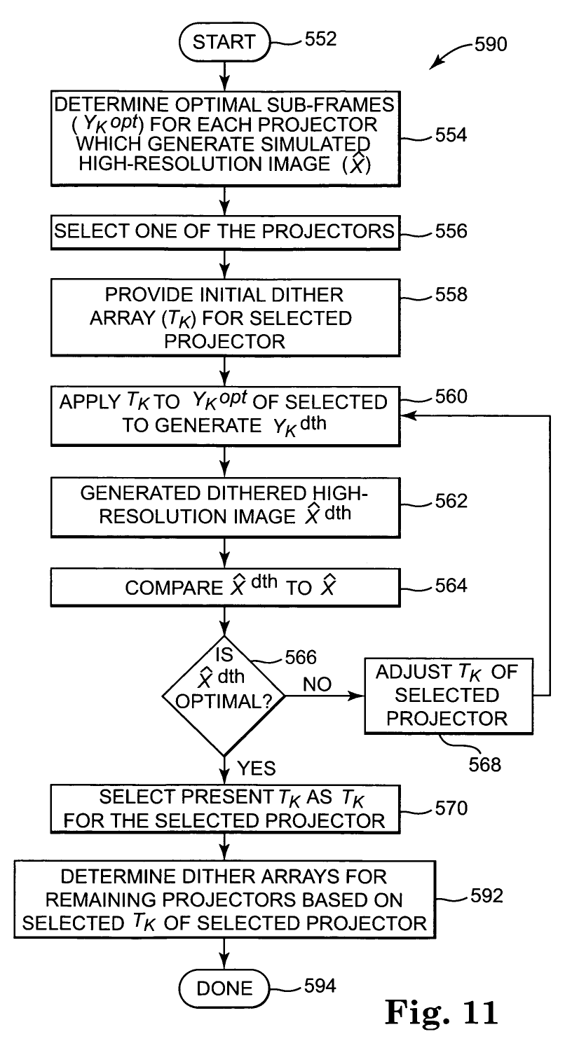

FIG. 11 is a flow diagram illustrating one embodiment of a process 590 for determining dither arrays for component projectors of a multi-projector image display system, such as component projectors 112 of image display system 100. As illustrated, 552 through 570 of process 590 are identical to process 550 described above with respect to FIG. 10. At 570, after selecting the present dither array 502 (Tₖ) as the dither array for the selected one of the component projectors 112, process 590 proceeds to 592.

At 592, the dither array 502 (Tₖ) of the selected component projector 112 (e.g. component projector 112A), as determined at 554 through 570, is employed to generate the dither arrays 502 (Tₖ) of the remaining, non-selected component projectors 112 (e.g. 112B, 112C, etc.). In one embodiment, different shifts, orientations, and inversions of dither array 502 (Tₖ) of the selected component projector 112 are employed to generate dither arrays 502 (Tₖ) for the remaining, non-selected component projectors 112. For example, in one embodiment, a 90-degree rotation of the determined dither array 502 (Tₖ) of the selected component projector (e.g. component projector 112A) is employed to generate a dither array 502 (Tₖ) of one of the remaining component projectors (e.g. component projector 112B). In one embodiment, a gray-level inversion of the determined dither array 502 (Tₖ) of the selected component projector (e.g. component projector 112A) is employed to generate a dither array 502 (Tₖ) of one of the remaining component projectors (e.g. component projector 112B). Any number of such techniques or combinations of such techniques can be employed to form dither arrays 502 (Tₖ) for the remaining component projectors from dither array 502 (Tₖ) of the selected component projector. Upon generating dither arrays 502 (Tₖ) for the remaining component projectors at 592, process 590 is complete, as indicated at 594.

As such, with regard to process 590, it is noted that the dither arrays 502 (Tₖ) of component projectors 112 are “coupled” to one another. In other words, a change in the dither array 502 (Tₖ) of the selected component projector 112 (e.g. component projector 112A) affects the dither arrays 502 (Tₖ) of the remaining component projectors 112 (e.g. component projectors 112B, 112C, etc.).

FIG. 12 is a flow diagram illustrating one embodiment of a process 600 for determining dither arrays for component projectors of a multi-projector image display system, such as component projectors 112 of image display system 100. Process 600 begins at 602. At 604, in a fashion similar to that described above with respect to FIG. 4, an image formation model is employed to generate optimal sub-frames 310 (Yₖ^{opt}) for each component projector 112 which generate a simulated high resolution image 306 (X-hat) which is substantially equal to a selected high resolution image 308 (X). As described above, in one embodiment, selected high resolution image 308 (X) is selected to have certain desirable attributes (e.g. wide color and intensity range, etc.).

At 606, dither arrays 502 (Tₖ) having an initial dither pattern are determined for each of the component projectors 112. In one embodiment, the initial dither pattern for each dither array 502 (Tₖ) is a random pattern. In one embodiment, the initial dither pattern is the same for each dither array 502 (Tₖ) for each of the component projectors 112. In another embodiment, the initial dither pattern is different (e.g. random) for each dither array 502 (Tₖ) for each of the component projectors 112.

At 608, the dither array 502 (Tₖ) for each component projector is applied to the corresponding optimal sub-frame 310 (Yₖ^{opt}) determined at 604 to generate a dithered sub-frame 504 (Yₖ^{dth}) for each of the component projectors 112. At 610, one projector of the component projectors 112 is selected, such as component projector 112A, for example.

At 612, an image formation model such as described above with respect to FIG. 9, generates a dithered high-resolution image 506 (X-hat^{dth}) based on the dithered low-resolution sub-frames 504 (Yₖ^{dth}) of each of the component projectors 112. As such, according to process 600, dithered low-resolution sub-frames 504 (Yₖ^{dth}) for the non-selected component projectors 112 are employed to generate the dithered high-resolution image 506 (X-hat^{dth}), unlike processes 550 and 590 of FIGS. 10 and 11 and as indicated by FIG. 9 wherein the optimal low-resolution sub-frames 310′ (Yₖ^{opt}) are employed for the non-selected projectors.

At 614, the dithered high-resolution image 506 (X-hat^{dth}) generated at 612 is compared to simulated high resolution image 306 (X-hat) determined at 604. At 616, based on the comparison at 614, it is queried whether dithered high-resolution image 506 (X-hat^{dth}) is optimal relative to simulated high resolution image 306 (X-hat).

If the answer to the query at 616 is “no”, process 600 proceeds to 618 where the dither pattern of dither array 502 (Tₖ) for the selected component projected 112 is adjusted based on an error between dithered high-resolution image 506 (X-hat^{dth}) and simulated high resolution image 306 (X-hat), such as described above with respect to FIG. 9. As described above with respect to FIG. 9, various techniques may be employed to efficiently adjust the pattern of dither or threshold values of dither array 502 (Tₖ), such as, for example, swap and toggle techniques.

At 620, a new dithered low-resolution sub-frame 504 (Yₖ^{dth}) for the selected component projector 112 is generated by applying the adjusted dither array 502 (Tₖ) to the corresponding optimal low-resolution sub-frame 310 (Yₖ^{opt}). Process 600 then returns to 612 where a new dithered high-resolution image 506 (X-hat^{dth}) is generated using the new dithered low-resolution sub-frame 504 (Yₖ^{dth}) for the selected component projector 112, and 614 and 616 are repeated.

If the answer to the query at 616 is “yes”, process 600 proceeds to 622 where the present dither array 502 (Tₖ) is set as the dither array for the selected one of the component projectors 112 (e.g component projector 112A). In one embodiment, the present dither array 502 (Tₖ) is set as the dither array for the selected one of the component projectors 112 and stored at a memory therein.

At 624, process 600 queries whether a dither array 502 (Tₖ) has been determined for each of the component projectors 112 of the multi-projector display system 100. If the answer to the query at 624 is “no”, process 600 proceeds to 626 where a next one of the component projectors 112 is selected and repeats the above described process so as to determine an optimal dither array 502 (Tₖ) for the next projector. If the answer to the query at 624 is “yes”, an optimal dither array 502 (Tₖ) has been determined for each of the component projectors, thereby completing process 600, as illustrated at 628.

With regard to process 600, it is noted that the dither arrays 502 (Tₖ) of the component projectors 112 are jointly determined. As described above, when determining dither array 502 (Tₖ) for a selected component projector 112, the dither arrays 502 (Tₖ) for the non-selected projectors 112 are employed in the formation of the dithered high-resolution image 506 (X-hat^{dth}). As such, with regard to process 600, a change in the dither array 502 (Tₖ) of each component projector 112 affects the dither arrays 502 (Tₖ) of the other component projectors 112 of multi-projector image display system 100.

It is noted that FIGS. 9 through 12 as described above illustrate specific embodiments of methods and processes for determining jointly designed dither arrays for an overlapping multi-projector image display system and are not intended as a complete representation of all potential embodiments and implementations.

In summary, by employing jointly designed dither arrays (Tₖ) for each of the component projectors of multi-projector image display system as described herein, such as component projectors 112 of image display system 100, the bit-depth of the image display system can be increased.

Although described herein primarily in terms of employing dither matrices to dither the low-resolution sub-frames of each component projector, other methods or processes may be employed so long as the low-resolution sub-frames of each component projector are dithered differently from one another. Examples of such processes include, for example, applying a different quantization algorithm to each low-resolution sub-frame and introducing noise differently into each low-resolution sub-frame.

One form of the present invention provides an image display system 100 with multiple overlapped low-resolution projectors 112 coupled with an efficient real-time (e.g., video rates) image processing algorithm for generating sub-frames 110. In one embodiment, multiple low-resolution, low-cost projectors 112 are used to produce high resolution images 114 at high lumen levels, but at lower cost than existing high-resolution projection systems, such as a single, high-resolution, high-output projector. One form of the present invention provides a scalable image display system 100 that can provide virtually any desired resolution and brightness by adding any desired number of component projectors 112 to the system 100.

In some existing display systems, multiple low-resolution images are displayed with temporal and sub-pixel spatial offsets to enhance resolution. There are some important differences between these existing systems and embodiments of the present invention. For example, in one embodiment of the present invention, there is no need for circuitry to offset the projected sub-frames 110 temporally. In one form of the invention, the sub-frames 110 from the component projectors 112 are projected “in-sync”. As another example, unlike some existing systems where all of the sub-frames go through the same optics and the shifts between sub-frames are all simple translational shifts, in one form of the present invention, the sub-frames 110 are projected through the different optics of the multiple individual projectors 112. In one form of the invention, the signal processing model that is used to generate optimal sub-frames 110 takes into account relative geometric distortion among the component sub-frames 110, and is robust to minor calibration errors and noise.

It can be difficult to accurately align projectors into a desired configuration. In one embodiment of the invention, regardless of what the particular projector configuration is, even if it is not an optimal alignment, sub-frame generator 108 determines and generates optimal sub-frames 110 for that particular configuration.

Algorithms that seek to enhance resolution by offsetting multiple projection elements have been previously proposed. These methods assume simple shift offsets between projectors, use frequency domain analyses, and rely on heuristic methods to compute component sub-frames. In contrast, one form of the present invention utilizes an optimal real-time sub-frame generation algorithm that explicitly accounts for arbitrary relative geometric distortion (not limited to homographies) between the component projectors 112, including distortions that occur due to a target surface 116 that is non-planar or has surface non-uniformities. One form of the present invention generates sub-frames 110 based on a geometric relationship between a hypothetical high-resolution reference projector 118 at any arbitrary location and each of the actual low-resolution projectors 112, which may also be positioned at any arbitrary location.

In one embodiment, image display system 100 is configured to project images 114 that have a three-dimensional (3D) appearance. In 3D image display systems, two images, each with a different polarization, are simultaneously projected by two different projectors. One image corresponds to the left eye, and the other image corresponds to the right eye. Conventional 3D image display systems typically suffer from a lack of brightness. In contrast, with one embodiment of the present invention, a first plurality of the projectors 112 may be used to produce any desired brightness for the first image (e.g., left eye image), and a second plurality of the projectors 112 may be used to produce any desired brightness for the second image (e.g., right eye image). In another embodiment, image display system 100 may be combined or used with other display systems or display techniques, such as tiled displays.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein. Therefore, it is intended that this invention be limited only by the claims and the equivalents thereof.

What is claimed is:

1. A method of displaying a high-resolution image, comprising:
receiving a high-resolution image frame representative of a high-resolution image;
generating a low-resolution sub-frame for each projector of a multi-projector display system based on the high-resolution image frame, each low-resolution sub-frame comprising a plurality of pixels with each pixel having an intensity level, wherein each projector projects a maximum number of unique intensity levels;
dithering the intensity levels of the pixels of each low-resolution sub-frame to one of the unique intensity levels of the associated projector differently for each projector to form a dithered low-resolution sub-frame such that the dithered low-resolution sub-frames, when simultaneously projected in an overlapping fashion, form a projected image representative of the high-resolution image and having a maximum number of unique projected intensity levels substantially equal to a sum of the maximum number of unique intensity levels of all the projectors.

2. The method of claim 1, wherein the generating includes generating each low-resolution sub-frame with an image formation model such that that the low-resolution sub-frames together form a simulated high-resolution image frame which is optimal relative to the high-resolution image frame.

3. The method of claim 1, wherein the dithering includes applying a corresponding dither array having a dither pattern to each low-resolution sub-frame to form the dithered low-resolution sub-frames, wherein the dither patterns of the dither array are jointly determined.

4. The method of claim 3, wherein the dithering includes determining a dither array for a selected one of the projectors and determining a dither array for each of the remaining projectors based on the dither array of the selected one of the projectors.

5. The method of claim 3, wherein the dithering includes providing a dither array having a random initial dither pattern and successively selecting and determining the dither pattern for the dither array of each of the projectors based on the dither patterns of dither arrays of previously selected projectors of the display system and on the random initial dither pattern of dither arrays of yet to be selected projectors of the display system.

6. The method of claim 3, wherein each dither pattern of each dither array includes one or more series of N dither values, where N is equal to the number of unique intensity levels of the corresponding projector and each dither value of a series corresponds to a different one of the unique intensity levels.

7. The method of claim 3, wherein each dither array is determined at manufacture of the multi-projector display system.

8. A method of jointly determining dither arrays for a multi-projector display system, comprising:
generating a low-resolution sub-frame for each projector of the multi-projector display system based on a high-resolution image frame, wherein the low-resolution sub-frames together form a simulated high-resolution image frame;
providing a dither array having a dither pattern for each of the projectors, each dither array having an initial dither pattern;
selecting one of the projectors;
applying each dither array to the low-resolution sub-frame of the corresponding projector to generate a dithered low-resolution sub-frame;
generating a dithered high-resolution image frame based on the dithered low-resolution sub-frames of each of the projectors; and
determining an error between the dithered high-resolution image frame and the simulated high-resolution image frame.

9. The method of claim 8, wherein generating the low-resolution sub-frame for each projectors includes employing an image formation model to optimize the simulated high-resolution image frame relative to the high-resolution image frame.

10. The method of claim 8, further comprising:
obtaining an adjusted dither array for the dither array of the selected projector by iteratively adjusting the dither pattern based on the error until the dithered high-resolution image frame is substantially optimized relative to the simulated high-resolution image frame; and
setting the dither pattern of the dither array of the selected projector to the adjusted dither pattern.

11. The method of claim 10, further comprising selecting a next one of the projectors and repeating the applying, generating, determining, obtaining, setting, and selecting until the dither array of each projector has been set to an adjusted dither pattern.

12. The method of claim 8, wherein the initial dither pattern of the dither array for each projector comprises a random pattern.

13. The method of claim 8, wherein determining the error includes filtering and weighting the error between the dithered high-resolution image frame and the simulated high-resolution image frame with a weighting filter approximating a response of a human visual system.

14. The method of claim 10, wherein the dithered high-resolution image frame is substantially optimized when the dithered high-resolution image frame converges with the simulated high-resolution image frame.

15. The method of claim 10, wherein the dithered high-resolution image frame is substantially optimized after a specified number of iterations.

16. A method of determining dither arrays for projectors of an overlapping multi-projector display system, the method comprising:
generating a low-resolution sub-frame for each projector of the multi-projector display system based on a high-resolution image frame, wherein the low-resolution sub-frames together form a simulated high-resolution image frame;
selecting one of the projectors;
applying a dither array having a dither pattern to the low-resolution sub-frame of the selected projector to generate a dithered low-resolution sub-frame;
generating a dithered high-resolution image frame based on the dithered low-resolution sub-frame of the selected projector and the low-resolution sub-frames of the non-selected projectors; and
determining an error between the dithered high-resolution image frame and the simulated high-resolution image frame.

17. The method of claim 16, wherein generating the low-resolution sub-frame for each projector includes employing an image formation model so as to optimize the simulated high-resolution image frame relative to the high-resolution image frame.

18. The method of claim 16, further comprising:
obtaining an adjusted dither array for the selected projector by iteratively adjusting the dither pattern based on the error until the dithered high-resolution image frame is substantially optimized relative to the simulated high-resolution image frame; and
setting the adjusted dither array as the dither for the selected projector.

19. The method of claim 18, further including repeating the selecting, applying, generating, determining, obtaining, and setting for each projector of the multi-projector display system.

20. The method of claim 18, further including determining a dither array for each of the non-selected projectors based on the adjusted dither array of the selected projector.

21. The method of claim 20, wherein the dither array for each of the non-selected projectors comprises a different function of the adjusted dither array of the selected projector.

22. The method of claim 21, wherein the function comprises a rotation of the, adjusted dither array of the selected projector.

23. The method of claim 21, wherein the function comprises a gray level inversion of the adjusted dither array of the selected projector.

24. A display system for displaying a high-resolution image, comprising:
a plurality of projection devices, each projection device capable of projecting a maximum number of unique intensity levels and having a dither array stored therein;
a buffer configured to receive a high-resolution image frame representative of a high resolution image; and
a sub-frame generator configured to generate with an image formation model a low-resolution sub-frame for each projector such that that the low-resolution sub-frames together form a simulated high-resolution image frame which is optimal relative to the high-resolution image frame, wherein each low-resolution sub-frame includes a plurality of pixels each having an intensity level, and configured to dither the intensity level of each pixel of each low-resolution sub-frame to one of the unique intensity levels of the associated projection device using the corresponding dither array having a dither pattern to form corresponding dithered low-resolution sub-frames, wherein the dither patterns of the dither arrays are jointly configured such that the dithered low-resolution sub-frames, when simultaneously projected in an overlapping fashion, form a projected image representative of the high-resolution image and having a maximum number of unique projected intensity levels substantially equal to a sum of the maximum number of unique intensity levels of all of the projection devices.
